(19) United States
(12) Patent Application Publication
(10) Pub. No.: US 2009/0303601 A1
(43) Pub. Date: Dec. 10, 2009

(54) MULTI-CAVITY OPTICAL FILTERS WITH INVERSE PARABOLIC GROUP DELAY RESPONSES

(76) Inventors: Serge Doucet, Quebec (CA); Sophie Larochelle, Quebec (CA)

Correspondence Address: OGILVY RENAULT LLP, 1, Place Ville Marie, SUITE 2500, MONTREAL, QC, H3B 1R1, CA

(21) Appl. No.: 12/442,553

(22) PCT Filed: Sep. 26, 2007
(86) PCT No.: PCT/CA2007/001724

§ 371 Date: Mar. 24, 2009

Related U.S. Application Data
(60) Provisional application No. 60/847,098, filed on Sep. 26, 2006.

(51) Int. Cl. G02F 1/225; G06F 19/00; G02B 5/28; G02B 6/34; G01J 3/00

(52) U.S. Cl. 359/578; 702/1; 359/577; 385/37; 356/300

(57) ABSTRACT

There is provided a multi-cavity optical filter providing a substantially parabolic group delay response with a negative second derivative over a wide bandwidth. The optical filter is made by cascading a plurality of reflective elements wherein a highly reflective element is not positioned at the end of the cascade but is rather inserted between elements of lower reflectivity. The resulting filter has a substantially parabolic group delay response with a negative second derivative when light is injected in one direction of light injection.

### CROSS-REFERENCE TO RELATED APPLICATIONS

This application claims priority under 35USC§119(e) of U.S. provisional patent application 60/847,098 filed Sep. 26, 2006, the specification of which being hereby incorporated by reference.

### TECHNICAL FIELD

The invention relates to optical filters. More particularly, the invention relates to multi-cavity optical filters having parabolic group delay responses and which can be combined to provide tunable dispersion compensators.

### BACKGROUND OF THE ART

A Gires-Tournois etalon or interferometer is characterized by the fact that the end mirror of the interferometer is highly reflective with a reflectivity often close to 100%. Gires-Tournois etalons used in reflection are therefore considered all-pass filters, this means that the amplitude of their spectral response is constant and close to 100% over the wavelength band of interest. The group delay responses however exhibit resonances at the wavelengths corresponding to the modes of the etalon cavity. As described for example in U.S. Pat. No. 7,251,396 to Larochelle et al., tunable dispersion compensating devices can be obtained by cascading two Gires-Tournois etalons with complementary group delay responses, i.e. almost parabolic group delay spectral responses with one etalon having a positive chromatic dispersion slope and the other one having a negative chromatic dispersion slope. A spectral shift of the spectral response of one Gires-Tournois etalon with respect to the response of the second one results in tuning of the chromatic dispersion of the total device. However, the main difficulty when designing chromatic dispersion compensators based on Gires-Tournois Etalons is that a negative chromatic dispersion slope is difficult to obtain on a wide portion of the free spectral range.

Making filters having a parabolic group delay response with a negative second derivative is a challenging task for Gires-Tournois etalon designs and there is a trade off between the channel bandwidth and the peak group delay that severely limits the performance of the chromatic dispersion compensator design by limiting its tuning range.

### SUMMARY

There is provided a multi-cavity optical filter providing a substantially parabolic group delay response with a negative second derivative over a wide bandwidth. The optical filter is made by cascading a plurality of reflective elements wherein a highly reflective element is not positioned at the end of the cascade but is rather inserted between elements of lower reflectivity. The resulting filter has a substantially parabolic group delay response with a negative second derivative when light is injected in one direction of light injection.

It is noted that the provided optical filter can be used in the two directions of light injection, i.e. light can be injected from one side or from the other side of the filter. The amplitude response spectrum is quite identical for the two directions of light injection and the group delay response is substantially parabolic over a bandwidth corresponding to about one free spectral range of the filter for both light injection directions. Furthermore, in some specific embodiments described herein, the group delay response spectrum is also similar in both directions, but reversed, i.e. same absolute value of the second derivative. The group delay responses in direct and inverse directions are then said to be complementary.

One application of the provided optical filter is in the manufacturing of tunable chromatic dispersion compensators. Two optical filters having complimentary parabolic group delay characteristics are cascaded. The first filter has a parabolic group delay response with a positive second derivative and the second filter has a parabolic group delay response with a negative second derivative. The chromatic dispersion tuning is obtained by shifting the spectral responses of the two filters relative to one another. Using the proposed optical filter configuration, a same configuration of reflective elements may be used in both optical filters, one optical filter using the configuration in a first direction of light injection and the other optical filter using the same configuration but in the opposite direction of light injection.

One aspect of the invention provides a multi-cavity optical filter having a first and a second direction of light injection. The optical filter comprises a highly reflective element, and a front reflective element and a back reflective element, each having a reflectivity lower than that of the highly reflective element. The front reflective element being located on one side of the highly reflective element and forming a front optical cavity with the highly reflective element. The back reflective element being located on the other side of the highly reflective element and forming a back optical cavity with the highly reflective element. The first and the second cavities having a phase difference of π. The optical filter shows a first substantially parabolic group delay response with a negative second derivative when light is injected in a first direction of light injection.

Another aspect of the invention provides a multi-cavity optical filter having a first and a second direction of light injection. The optical filter comprises a plurality of cascaded reflective elements comprising a highly reflective element having a reflectivity higher than other ones of the reflective elements, and at least one element of lower reflectivity on each side of the highly reflective element. The reflective elements provide a plurality of optical cavities. The optical filter is characterized by a free spectral range and shows a first substantially parabolic group delay response with a negative second derivative over a spectral bandwidth corresponding to the free spectral range when light is injected in the first direction.

Another aspect of the invention provides a tunable chromatic dispersion compensator. The tunable chromatic dispersion compensator comprises a first optical filter having a first substantially parabolic group delay response with a negative second derivative and a second optical filter having a second substantially parabolic group delay response with a positive second derivative. The first and the second optical filters are optically cascaded to provide a substantially linear total group delay response having a slope defining a chromatic dispersion. The tunable chromatic dispersion compensator further comprises tuning means for shifting in wavelength the first substantially parabolic group delay response and for shifting in wavelength the second substantially parabolic group delay response. The first and the second optical filter to be shifted in opposite wavelength directions to tune the chromatic dispersion. The first and the second optical filters comprise the same arrangement of a plurality of cascaded reflective elements. The plurality of cascaded reflective elements has a first and a second direction of light injection, the first and the second optical filters being cascaded such that an optical signal is to enter the first optical filter in the first direction of light injection and to enter the second optical filter in the second direction of light injection. The reflective elements comprise a highly reflective element having a reflectivity higher than other ones of the reflective elements, and at least one element of lower reflectivity on each side of the highly reflective element. The reflective elements providing a plurality of optical cavities.

Another aspect of the invention provides a method for manufacturing a multi-channel optical filter based on Bragg gratings. An arrangement of a plurality of cascaded reflective elements is provided. The arrangement comprises a highly reflective element having a reflectivity higher than other ones of the reflective elements, and at least one element of lower reflectivity on each side of the highly reflecting element, the reflective elements providing a plurality of optical cavities characterized by a free spectral range. The optical response of the arrangement is calculated over an optical bandwidth substantially corresponding to the free spectral range, the optical response defining a unitary target optical response. The unitary target response shows a substantially parabolic group delay response A multi-channel target optical response is provided by replicating the unitary target optical response in wavelength. The multi-channel target response has a maximum reflectivity lower than 0 dB. A Bragg grating profile is computed based on the target optical response. The Bragg grating profile shows a parabolic group delay response with a negative second derivative over said optical bandwidth for one direction of light injection. Finally, the profile is written in an optical waveguide to provide the optical filter.

Another aspect of the invention provides a method for determining a Bragg grating profile. An arrangement of a plurality of cascaded reflective elements is provided. The arrangement comprises a highly reflective element having a reflectivity higher than other ones of the reflective elements, and at least one element of lower reflectivity on each side of the highly reflecting element, the reflective elements providing a plurality of optical cavities characterized by a free spectral range. The optical response of the arrangement is calculated over an optical bandwidth substantially corresponding to the free spectral range, the optical response defining a unitary target optical response. The unitary target response shows a substantially parabolic group delay response A multi-channel target optical response is provided by replicating the unitary target optical response in wavelength. The multi-channel target response has a maximum reflectivity lower than 0 dB. A Bragg grating profile is computed based on the target optical response. The Bragg grating profile shows a parabolic group delay response with a negative second derivative over said optical bandwidth for one direction of light injection. Finally, the profile is outputted.

It is noted that in this specification, the term “highly reflective element” is meant to mean the element of an arrangement having the highest reflectivity among all the elements of the arrangement, and is not meant to mean an element having a high reflectivity. The value of the reflectivity of the “highly reflective element” may be as low, or even below, 25%.

### BRIEF DESCRIPTION OF THE DRAWINGS

FIG. 1 is a block diagram illustrating a multi-cavity optical filter in accordance with a proposed configuration;

FIG. 2 shows the z-transform equivalent of a discrete reflective element, FIG. 2A being a schematic illustrating the discrete reflective element and FIG. 2B being a mathematic block diagram illustrating the z-transform equivalent of a discrete reflective element.

FIG. 3 shows the z-transform equivalent of a cavity created by two discrete reflective elements, FIG. 3A being a schematic illustrating the cavity and FIG. 3B being a mathematic block diagram illustrating the z-transform equivalent of the cavity.

FIG. 4 illustrates a typical two-cavity Gires-Tournois filter, FIG. 4A being a schematic representing the filter characteristics and FIGS. 4B and 4C being graphs showing respectively the reflection amplitude response and the group delay response of the two-cavity Gires-Tournois filter over a one 50-GHz free spectral range, the solid-line curve corresponding to the spectral response in direct light injection and the dotted solid-line curve corresponding to the spectral response in inverse light injection;

FIG. 5 illustrates a typical three-cavity Gires-Tournois filter, FIG. 5A being a schematic representing the filter characteristics and FIGS. 5B and 5C being graphs showing respectively the reflection amplitude response and the group delay response of the three-cavity Gires-Tournois filter over one 50-GHz free spectral range, the solid-line curve corresponding to the spectral response in direct light injection and the dotted solid-line curve corresponding to the spectral response in inverse light injection;

FIG. 6 illustrates an example two-cavity Gires-Tournois filter with a phase mismatch, FIG. 6A being a schematic representing the filter characteristics and FIGS. 6B and 6C being graphs showing respectively the reflection amplitude response and the group delay response of the Gires-Tournois filter over one 50-GHz free spectral range, the solid-line curve corresponding to the spectral response in direct light injection and the dotted solid-line curve corresponding to the spectral response in inverse light injection;

FIG. 7 illustrates an example Gires-Tournois filter with two cavities having a phase of π, FIG. 7A being a schematic representing the filter characteristics and FIGS. 7B and 7C being graphs showing respectively the reflection amplitude response and the group delay response of the Gires-Tournois filter over one 50-GHz free spectral range, the solid-line curve corresponding to the spectral response in direct light injection and the dotted solid-line curve corresponding to the spectral response in inverse light injection;

FIG. 8 illustrates an arrangement of a multi-cavity filter in accordance with a proposed configuration wherein a highly reflective mirror is located between decreasingly reflective mirrors, FIG. 8A being a schematic representing the filter characteristics and FIGS. 8B and 8C being graphs showing respectively the reflection amplitude response and the group delay response of the multi-cavity filter over one 50-GHz free spectral range, the solid-line curve corresponding to the spectral response in direct light injection and the dotted solid-line curve corresponding to the spectral response in inverse light injection;

FIG. 9 shows an example of unitary spectrum which is used as an initial start point in the design of a Bragg grating filter, FIGS. 9A and 9B being graphs showing respectively the reflection amplitude spectrum and the group delay spectrum, the solid-line curve corresponding to the unitary spectrum and the white dots curve on FIG. 9B corresponding to a parabolic fit over the unitary group delay spectrum;

FIG. 10 shows an initial target multi-channel spectrum provided by replicating the spectrum of FIG. 9 in wavelength and used to design a Bragg grating profile, FIGS. 10A and 10B being graphs showing respectively the target reflection amplitude spectrum and the target group delay spectrum;

FIG. 11 shows a Bragg grating profile designed using an inverse scattering algorithm applied on the initial target multi-channel spectrum of FIG. 10; FIG. 11A being a graph showing the modulation index profile; FIG. 11B being a graph showing the reflection amplitude spectrum corresponding to the designed Bragg grating, wherein the solid-line curve corresponds to the target reflectivity spectrum, the white dots curve corresponds to the reflectivity response of the calculated Bragg grating in direct direction of light injection minus 1 dB, and the black dots curve shows the reflectivity response in inverse direction of light injection minus 2 dB; and FIG. 11C being a graph showing the group delay spectrum, wherein the solid-line curve corresponds to the target group delay spectrum, the while dots curve corresponds to the group delay response of the calculated Bragg grating in direct direction of light injection minus 25 ps, and the black dots curve corresponds to the group delay response in inverse direction of light injection minus 50 ps;

FIG. 12 shows a Bragg grating profile designed using an inverse scattering algorithm applied on the initial target multi-channel spectrum of FIG. 10 but with a maximum reflectivity of −0.5 dB; FIG. 12A being a graph showing the modulation index profile; FIG. 12B being a graph showing the reflection amplitude spectrum corresponding to the designed Bragg grating, wherein the solid-line curve corresponds to the target reflectivity spectrum, the while dots curve corresponds to the reflectivity response of the calculated Bragg grating in direct direction of light injection minus 1 dB, and the black dots curve shows the reflectivity response in inverse direction of light injection minus 2 dB; and FIG. 12C being a graph showing the group delay spectrum, wherein the solid-line curve corresponds to the target group delay spectrum, the white dots curve corresponds to the group delay response of the calculated Bragg grating in direct direction of light injection minus 25 ps, the black dots curve corresponds to the group delay response in inverse direction of light injection minus 50 ps, and the dashed curve corresponds to the summation of direct and inverse the group delay responses;

FIG. 13 shows a Bragg grating profile designed using an inverse scattering algorithm applied on the initial target multi-channel spectrum of FIG. 10 but with a maximum reflectivity of −3 dB; FIG. 13A being a graph showing the modulation index profile; FIG. 13B being a graph showing the reflection amplitude spectrum corresponding to the designed Bragg grating, wherein the solid-line curve corresponds to the target reflectivity spectrum, the white dots curve corresponds to the reflectivity response of the calculated Bragg grating in direct direction of light injection minus 1 dB, and the black dots curve shows the reflectivity response in inverse direction of light injection minus 2 dB; and FIG. 13C being a graph showing the group delay spectrum, wherein the solid-line curve corresponds to the target group delay spectrum, the white dots curve corresponds to the group delay response of the calculated Bragg grating in direct direction of light injection minus 25 ps, the black dots curve corresponds to the group delay response in inverse direction of light injection minus 50 ps, and the dashed curve corresponds to the summation of direct and inverse the group delay responses;

FIG. 14 shows an initial target multi-channel spectrum provided by replicating the spectrum of FIG. 9 in wavelength and adding a group delay slope, FIGS. 14A and 14B being graphs showing respectively the target reflection amplitude spectrum and the target group delay spectrum;

FIG. 15 shows a Bragg grating profile designed using an inverse scattering algorithm applied on the initial target multi-channel spectrum of FIG. 14 but with a maximum reflectivity of −3 dB; FIG. 15A being a graph showing the modulation index profile; FIG. 15B being a graph showing the reflection amplitude spectrum corresponding to the designed Bragg grating, wherein the solid-line curve corresponds to the target reflectivity spectrum, the white dots curve corresponds to the reflectivity response of the calculated Bragg grating in direct direction of light injection minus 1 dB, and the black dot curve corresponds to the reflectivity response in inverse direction of light injection minus 2 dB; and FIG. 15C being a graph showing the group delay spectrum, wherein the solid-line curve corresponds to the target group delay spectrum, the white dots curve corresponds to the group delay response of the calculated Bragg grating in direct direction of light injection minus 25 ps, the black dots curve corresponds to the group delay response in inverse direction of light injection minus 50 ps, and the dashed curve corresponds to the summation of the direct and inverse group delay responses;

FIG. 16 shows an initial target multi-channel spectrum provided by inverting the group delay spectrum of FIG. 9 and replicating it in wavelength, FIGS. 16A and 16B being graphs showing respectively the target reflection amplitude spectrum and the target group delay spectrum;

FIG. 17 shows a Bragg grating profile designed using an inverse scattering algorithm applied on the initial target multi-channel spectrum of FIG. 16 but with a maximum reflectivity of −3 dB; FIG. 17A being a graph showing the modulation index profile; FIG. 17B being a graph showing the reflection amplitude spectrum corresponding to the designed Bragg grating, wherein the solid-line curve corresponds to the target reflectivity spectrum, the white dots curve corresponds to the reflectivity response of the calculated Bragg grating in direct direction of light injection minus 1 dB, and the black dots curve shows the reflectivity response in inverse direction of light injection minus 2 dB; and FIG. 17C being a graph showing the group delay spectrum, wherein the solid-line curve corresponds to the target group delay spectrum, the white dots curve corresponds to the group delay response of the calculated Bragg grating in direct direction of light injection minus 25 ps, the black dots curve corresponds to the group delay response in inverse direction of light injection minus 50 ps, and the dashed curve corresponds to the summation of the direct and inverse group delay responses;

FIG. 18 shows a Bragg grating profile designed using an inverse scattering algorithm applied on the initial target multi-channel spectrum of FIG. 16 but with a maximum reflectivity of −0.5 dB; FIG. 18A being a graph showing the modulation index profile; FIG. 18B being a graph showing the reflection amplitude spectrum corresponding to the designed Bragg grating, wherein the solid-line curve corresponds to the target reflectivity spectrum, the white dots curve corresponds to the reflectivity response of the calculated Bragg grating in direct direction of light injection minus 1 dB, and the black dots curve shows the reflectivity response in inverse direction of light injection minus 2 dB; and FIG. 18C being a graph showing the group delay spectrum, wherein the solid-line curve corresponds to the target group delay spectrum, the white dots curve corresponds to the group delay response of the calculated Bragg grating in direct direction of light injection minus 25 ps, the black dots curve corresponds to the group delay response in inverse direction of light injection minus 50 ps, and the dashed curve corresponds to the summation of the direct and inverse group delay responses;

FIG. 19 illustrates an analysis of the Bragg grating design of FIG. 13, FIGS. 19A, 19C, 19E and 19G being graphs respectively showing the separate modulation index profiles of grating 130, grating 131, grating 132 and grating 133 of the design of FIG. 13, and FIGS. 19B, 19D, 19F and 19H being graphs showing the numerically calculated reflection spectra respectively corresponding to grating 130, grating 131, grating 132 and grating 133;

FIG. 20 illustrates an analysis of the Bragg grating design of FIG. 13, FIGS. 20A, 20C, 20E and 20G being graphs respectively showing the separate modulation index profiles of grating 134, grating 135, grating 136 and grating 137 of the design of FIG. 13, and FIGS. 20B, 20D, 20F and 20H being graphs showing the numerically calculated reflection spectra respectively corresponding to grating 134, grating 135, grating 136 and grating 137;

FIG. 21 illustrates an analysis of the Bragg grating design of FIG. 13, FIGS. 21A, 21C, 21E and 21G being graphs showing the separate modulation index profiles of the cavities formed respectively by gratings 137 and 136, gratings 136 and 135, gratings 135 and 134 and gratings 134 and 133, and FIGS. 21B, 21D, 21F and 21H being graphs showing the numerically calculated reflectivity spectra respectively corresponding to the profiles of FIGS. 21A, 21C, 21E and 21G;

FIG. 22 compares the spectral response of the arrangement of discrete reflective elements identified using FIGS. 20 and 21, to the spectral response of the Bragg grating profile of FIG. 13, FIGS. 22A, 22B and 22C being graphs respectively showing the reflectivity spectrum, the group delay spectrum in direct light injection and the group delay spectrum in inverse light injection, wherein the solid-line curve corresponds to the simulated spectral response of the arrangement of reflective elements and the dotted curve corresponds to the spectral response of the Bragg grating profile;

FIG. 23 shows an example of a unitary spectral response obtained using the polynomial coefficients of Table 1, FIGS. 23A and 23B being graphs respectively showing the reflectivity spectrum and the group delay spectrum in direct light injection; and

FIG. 24 illustrates an example of a tunable dispersion compensator, FIG. 24A being a schematic illustrating the configuration of the tunable dispersion compensator and FIGS. 24B, 24C and 24D being graphs showing the group delay response respectively for a zero-tuned chromatic dispersion, a negatively tuned chromatic dispersion and a positively tuned chromatic dispersion.

It will be noted that throughout the appended drawings, like features are identified by like reference numerals.

### DETAILED DESCRIPTION

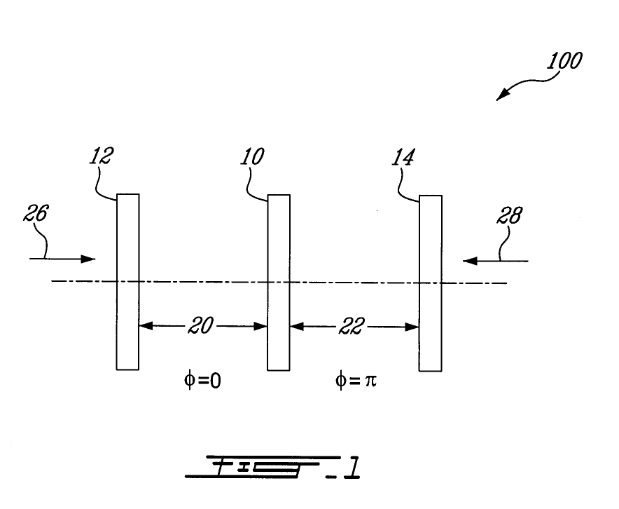

Now referring to the drawings, FIG. 1 schematically illustrates a multi-cavity optical filter 100 in accordance with the proposed configuration. The optical filter is made by cascading a plurality of reflective elements 10, 12, 14, or mirrors. As will be further described hereinbelow, the reflective element 10 has the highest reflectivity and is located between reflective elements 12, 14 of lower reflectivity. At least two optical cavities 20, 22 are thus created by the arrangement of the reflective elements 10, 12, 14. The cavities located on both sides of reflective element 14 are out of phase with a phase difference of π, i.e. they have a cavity optical length difference of one quarter of the central wavelength which spectrally shifts the resonant wavelengths of the two cavities relative to one another by one half of the FSR . In this case, the phase of the first cavity 20 is 0 while the phase of the second cavity 22 is π. The coupled cavities 20, 22 define a filter with a Free Spectral Range (FSR) which is inversely proportional to the distance between the reflective elements 10, 12, 14.

The resulting filter has a substantially parabolic group delay response with a positive second derivative (i.e. positive chromatic slope or positive curvature) over a bandwidth corresponding to the FSR when light is injected in a first direction 26 (direct) where light enters the optical filter through cavity 20. Furthermore, when light is injected in a second direction 28 (inverse) where light enters through the cavity 22, the optical filter 10 shows a substantially parabolic group delay response with a negative second derivative. Accordingly, the group delay response is substantially parabolic over a bandwidth corresponding to about one FSR of the filter for both directions of light injection 26, 28.

It is noted that the arrangement may comprise more than three reflective elements and that the element 14 having the highest reflectivity is not necessarily symmetrically in the center of the arrangement, but the reflective elements located on both sides of this mirror are typically of decreasing reflectivity toward both extremities of the optical filter. Examples of suitable arrangements are given further below.

The provided optical filter 100 may be made by cascading discrete reflective elements or using distributed reflective elements manufactured using chirped Bragg grating technology. Chirped Bragg gratings are typically manufactured in optical waveguides such as optical fibers (fiber Bragg gratings) or channel waveguides.

The spectral response of the proposed filter has some similarities with spectral responses of typical Gires-Tournois etalons or Distributed Gires-Tournois etalons when probing the filter by injecting light from one direction. However, when injecting light from the opposite direction, this novel filter also provides a parabolic group delay response which is similar to the group delay response in direct light injection, but inverted.

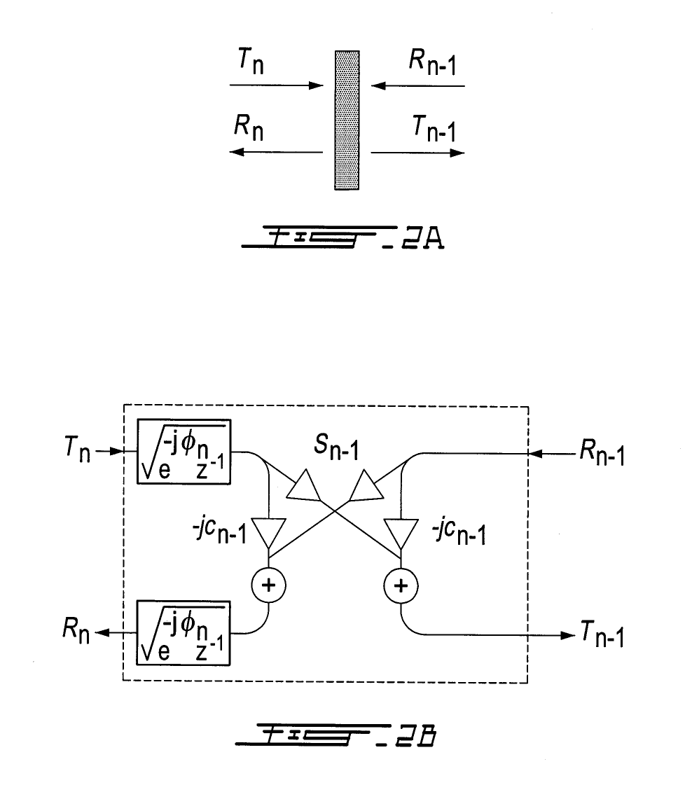

To simulate the spectral response of a specific mirror arrangement, a numerical tool as described in Madsen C. K., Laskowski E. J., Bailey J., Cappuzzo M. A., Chandrasekhar S., Gomez L. T., Griffin, A., Oswald P., Stulz L. W. “Compact integrated tunable dispersion compensators”, LEOS 2002, paper WAA1, vol. 2, p. 570-571 (2002), and using the z-transform to model the spectral response of the mirror arrangement is used. As illustrated in FIG. 2, each discrete mirror is described by its equivalent in z-transform, where Tₙ is the incident field, Rₙ is the reflected field and Tₙ₋₁ is the transmitted field of reflective element n, and Rₙ₋₁ is the field reflected by the following reflective element n−1 back to reflective element n, and where c and s are parameters which values depend on the mirror intensity transmissivity κ and are determined using the following equations:

−jcₙ₋₁=−j\sqrt{1−κₙ₋₁}; (1)

sₙ₋₁=\sqrt{κₙ₋₁}. (2)

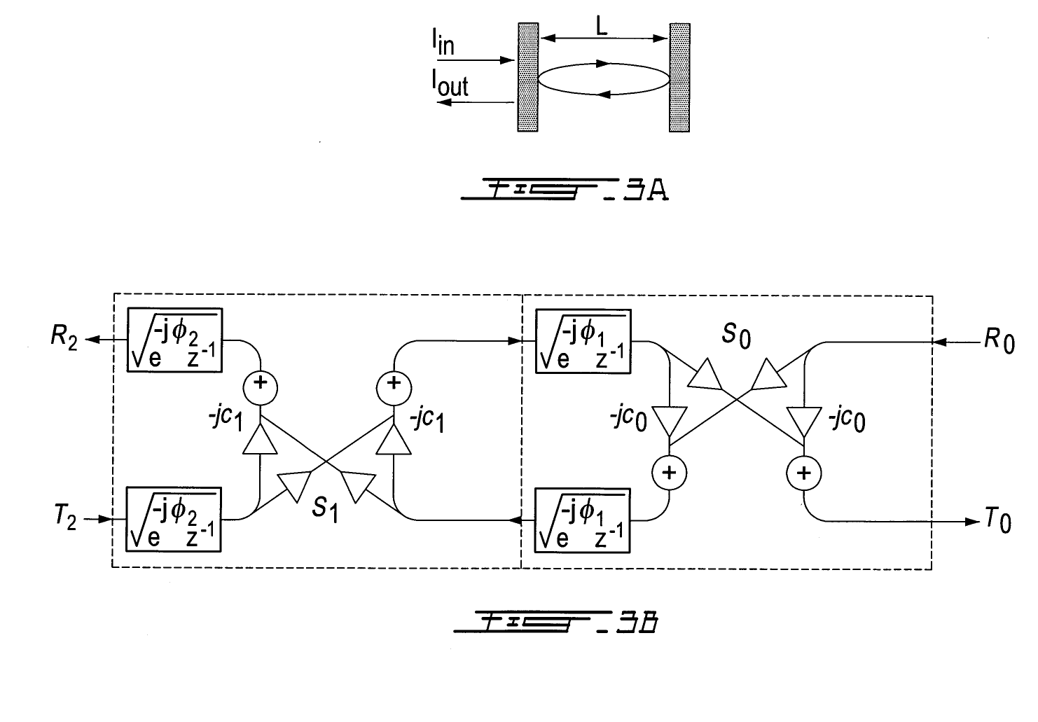

According to the partially reflective mirror model of FIG. 2, a matrix model can be used to consider a cascade of more than one mirror with:

$$[ \begin{matrix}{T}_{n} \\ {R}_{n}\end{matrix} ] = [ \begin{matrix}{A}_{n - 1} ( z ) & {B}_{n - 1}^{R} ( z ) \\ {B}_{n - 1} ( z ) & {A}_{n - 1}^{R} ( z )\end{matrix} ] [ \begin{matrix}{T}_{n - 1} \\ {R}_{n - 1}\end{matrix} ] , \qquad ( 3 )$$

where A(z) and B(z) are the z polynomials, which depend on the arrangement of reflective elements, and A^{R}ₙ₋₁(z) and B^{R}ₙ₋₁(z) are their reversal polynomials as will be detailed below. By considering equation (3) and polynomials A(z) and B(z), a coupled cavity filter with multiple reflective elements is constructed using the single mirror element model illustrated in FIG. 2. FIG. 3 shows an example of a single cavity filter.

The term φ corresponds to the cavity phase, i.e. the optical path difference relative to a specific cavity length, and z=e^{jω} where ω is the angular frequency. Considering the matrix product and the cavity phase term, the z polynomials A(z) and B(z) are calculated using the following recursive equations:

Aₙ(z)=Aₙ₋₁(z)+icₙ₋₁e^{-iφ}^{ₙ₋₁}Bₙ₋₁(z)n>1; (4)

Bₙ(z)=−icₙ₋₁Aₙ₋₁(z)+e^{-iφ}^{ₙ₋₁}z⁻¹Bₙ₋₁(z)n>1, (5)

and giving that A₁(z)=1, B₁(z)=−ic₀. The corresponding transmitted and reflection polynomials are calculated with:

$$\begin{matrix}{T}_{n} ( z ) = \frac{1}{{A}_{n} ( z )} ; & ( 6 ) \\ {R}_{n} ( z ) = \frac{{B}_{n} ( z )}{{A}_{n} ( z )} . & ( 7 )\end{matrix}$$

These polynomials are the transfer functions in transmission and reflection for a specific mirror setting. In the devices considered herein, only the reflection is of interest. The magnitude of the reflection R(ω) is calculated with

R(ω)=||Rₙ(z)|²|_{z=e}_{^{jω}} (8)

and the relative group delay τₙ(ω) is calculated with

$${τ}_{n} ( ω ) = - \frac{d}{d ω} {{tan}^{- 1} [ \frac{Im \{ {R}_{n} ( z ) \}}{Re \{ {R}_{n} ( z ) \}} ]}_{z = {e}^{j ω}} . \qquad ( 9 )$$

The absolute group delay is calculated by considering the time elapsing for one round trip of the light into each cavity. For example, for a FSR of 50 GHz, it corresponds to an in-fiber cavity length of 2 mm, the unit delay (T=1/FSR) being equal to T=20 ps. The absolute group delay GD(ω) is calculated using:

GD(ω)=τₙ(ω)T. (10)

Using the above model, the filter response can be calculated over a bandwidth corresponding to one FSR, for a specific mirror setting and cavity phase.

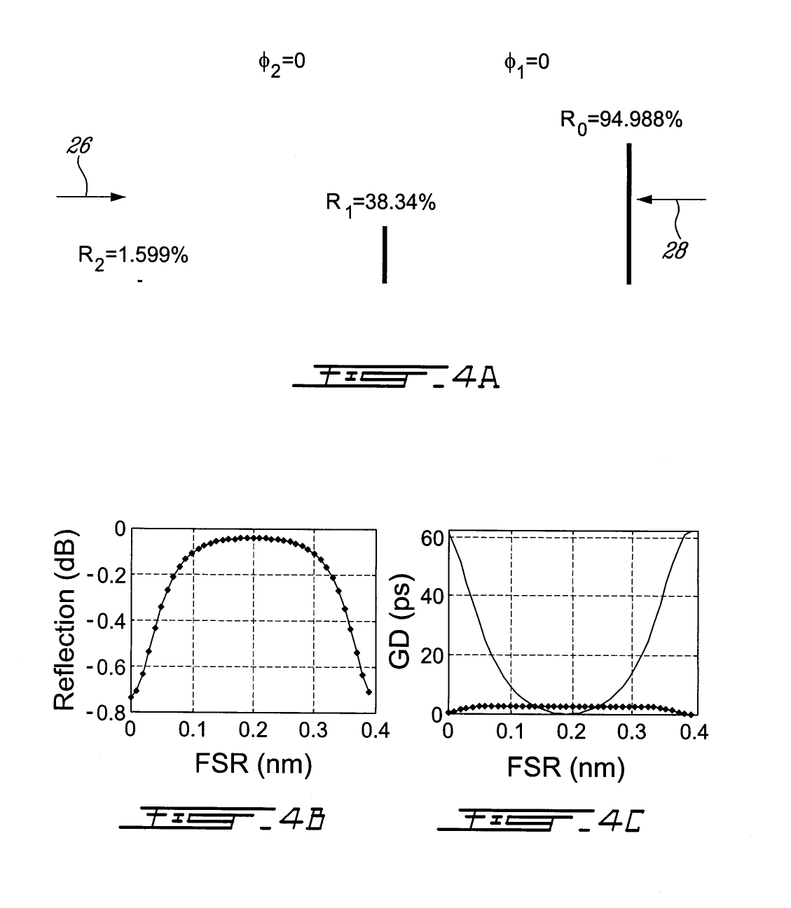

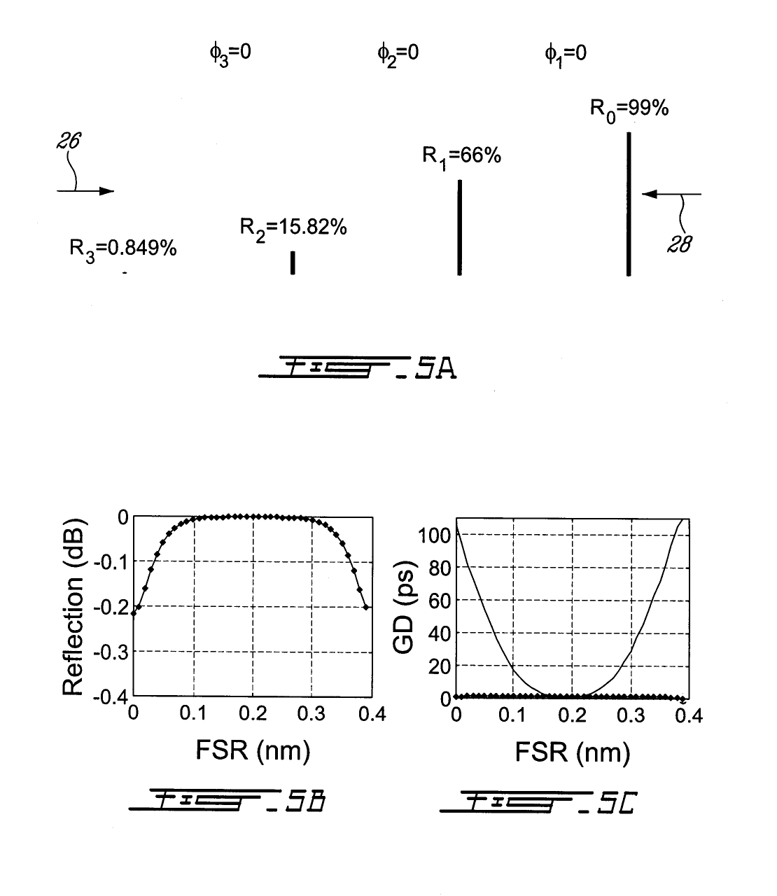

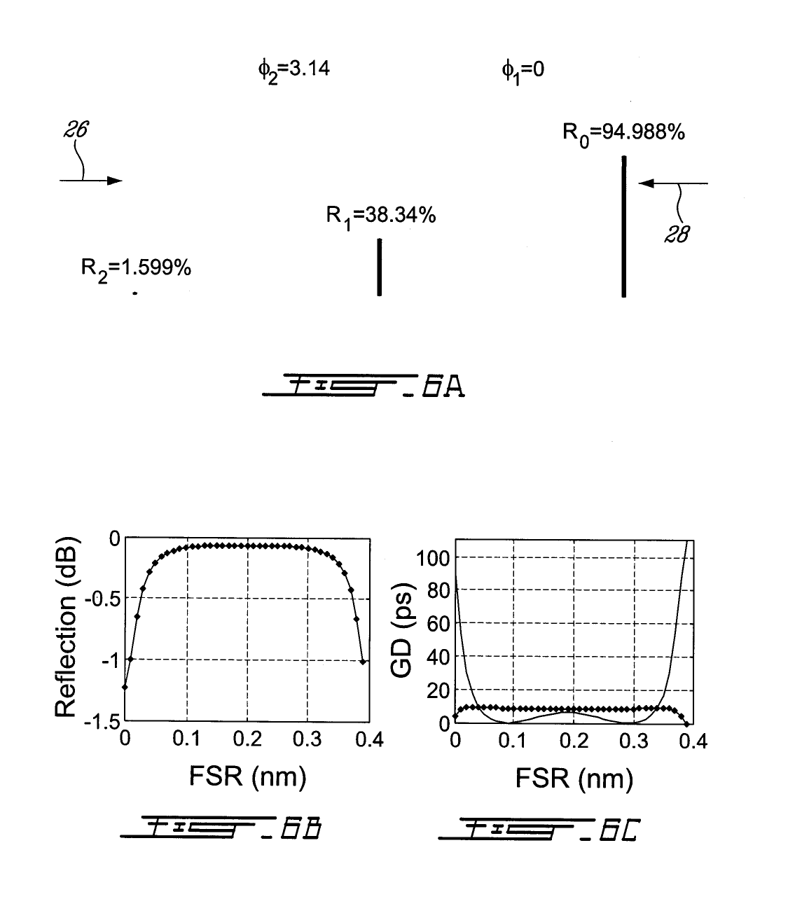

Typical multi-cavity Gires-Tournois etalons consist of a series of reflective elements of which the most reflective is placed at the end of the structure. FIG. 4 and FIG. 5 each illustrate a multi-cavity Gires-Tournois etalon having a positive chromatic dispersion slope (or positive second derivative of its group delay response). FIG. 4 illustrates a Gires-Tournois etalon consisting of two optical cavities while FIG. 5 illustrates one consisting of three optical cavities. In FIG. 4, FIG. 5 and also further below in FIGS. 6 to 8, subfigure A illustrates the reflective elements arrangement in the optical filter of which the amplitude response is shown in subfigure B and the group delay response is shown in subfigure C. The amplitude and group delay responses are calculated considering one FSR only and using the z-transform discrete mirror model. The reflectivity of each reflective elements n and the phase of each optical cavities m created between elements n and n−1 of the arrangement of FIG. 4 are as follows: R₂=1.599%, R₁=38.34%, R₀=94.988%; φ₂=0, φ₁=0. The arrangement of the optical filter of FIG. 5 is given by R₃=0.849%, R₂=15.82%, R₁=66%, R₀=99%; φ₃=0, φ₂=0, φ₁=0.

By comparing the graphs of FIG. 4 and FIG. 5, it can be seen that the use of a highly reflective end mirror provides a lower amplitude variation and that using additional cavities provides a higher maximum value of the group delay peak by maintaining the parabolic group delay shape over a wider range.

FIG. 4 and FIG. 5 show the optical spectrum of the reflected light when it is injected in the optical filter in the direct direction 26 (solid line) and in the inverse direction 28 (solid line with dots). These two examples demonstrate that the reflection amplitude is the same for both directions of light injection 26, 28 but that the group delay response is very different for both directions. Inversion of the light injection direction results in neither a similar nor an inverted group delay shape. When light is injected in the inverse direction 28, the group delay loses its desired parabolic shape.

To provide a parabolic group delay shape in a Gires-Tournois etalon, the phases of the optical cavities should be equal so that all the cavities are in a phase matching condition. FIG. 6 illustrates the impact of a phase mismatch on a two-cavity Gires-Tournois etalon arrangement. It shows that a parabolic group delay shape is not obtained in this case. The arrangement of the optical filter of FIG. 6 is given by R₂=1.599%, R₁=38.34%, R₀=94.988%; φ₂=π, φ₁=0.

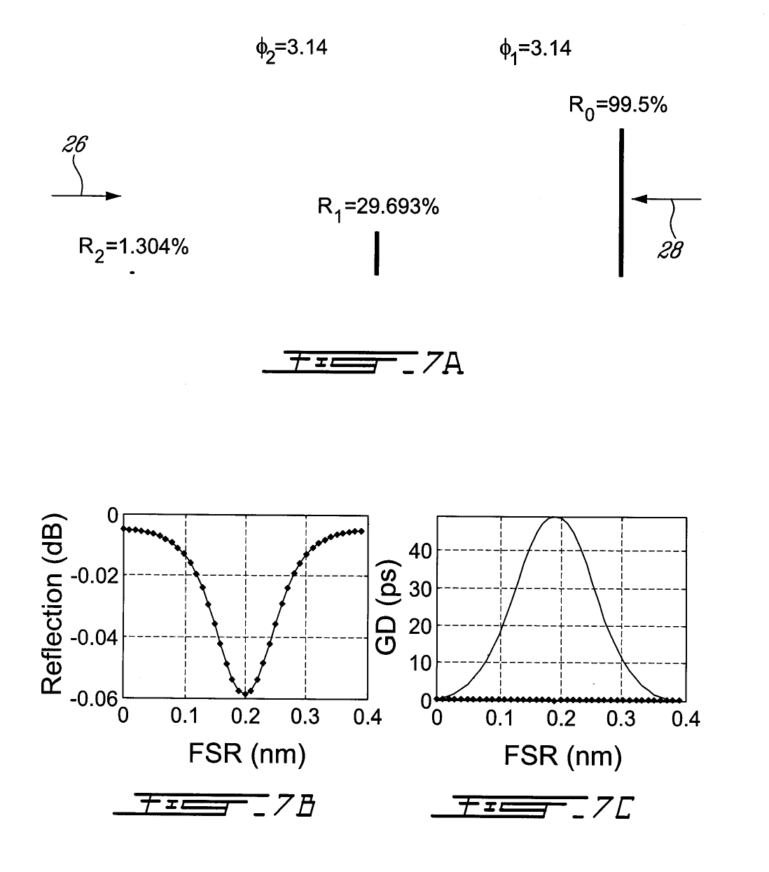

In order to provide a Gires-Tournois etalon with a negative chromatic dispersion slope, all phases of the Gires-Tournois etalon should be changed. This creates a group delay peak at the center of the bandwidth. New mirror reflectivity values are also selected for a better group delay fit to a parabolic shape. The arrangement of the optical filter of FIG. 7 is given by R₂=1.304%, R₁=29.693%, R₀=99.5%; φ₂=π, φ₁=π. In this case, the amplitude drop is located at the spectral position of the group delay peak, which is not desired, and the group delay response is not parabolic over a large bandwidth.

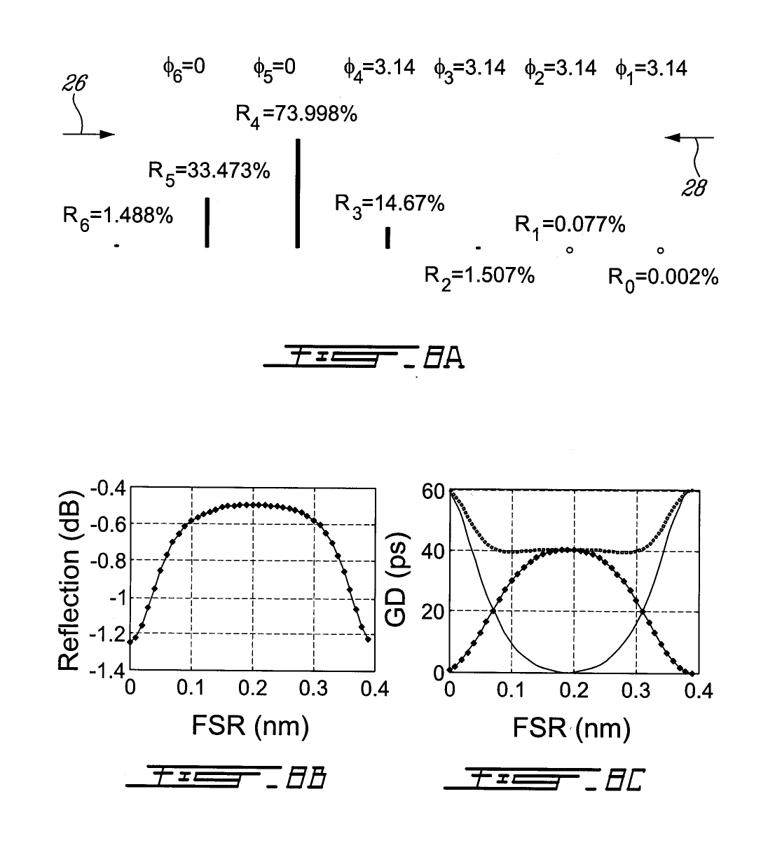

FIG. 8 illustrates an example of a multi-cavity optical filter in accordance with a configuration proposed in reference to FIG. 1. The arrangement of FIG. 8 consists of a multi-cavity structure where the highly reflective element (corresponding to R₄) is not placed at the end of the structure but is rather placed between reflective elements of lower reflectivity values. Furthermore, the cavities before and after the highly reflective mirror are out of phase with a phase difference of π. The arrangement of the optical filter of FIG. 8 is given by R₆=1.488%, R₅=33.473%, R₄=73.998%, R₃=14.67%, R₂=1.507%, R₁=0.077%, R₀=0.002%; φ₆=0, φ₅=0, φ₄=π, φ₃=π, φ₂=π, φ₁=π. The reflection spectrum of the resulting optical filter shows a parabolic group delay response in both direct direction 26 and inverse direction 26 of light injection. The direct and inverse group delay responses are similar but inverted, i.e. the second derivative of the group delay response is positive in the direct direction 26 and negative in the inverse direction 28. FIG. 8C also shows the summation of the direct injection and the inverse injection group delay responses. It can be seen that the summation provides a substantially flat curve over a wide range because the absolute value of the second derivative of the direct and inverse group delay response are substantially equal, which is the result of the inverted group delay response.

The proposed optical filter arrangement can be implemented using free space optics such as thin film coating etalons or it can be implemented in waveguides using superimposed fiber Bragg gratings or complex fiber Bragg gratings for example.

The reflectivity values of the reflective elements in a specific arrangement are selected to obtain the desired group delay curvature but the arrangement is typically characterized by an asymmetric mirror arrangement with decreasing reflectivity on both sides of the reflective element having the highest reflectivity.

The cavity length L depends on the desired FSR, the refractive group index n_{g} of the medium and the speed of light c:

$$L = \frac{c}{2 {n}_{g} FSR} \cdot \qquad ( 11 )$$

A cavity phase difference of π is obtained by introducing a cavity length difference (ΔL) which depends on the desired phase difference (Δφ), the average wavelength of the optical band of interest ( λ̅) and the average effective index (n_{eff}( λ̅)):

$$Δ L = \frac{Δ φ \overline{λ}}{4 {n}_{eff} ( \overline{λ} ) π} . \qquad ( 12 )$$

In one particular embodiment, the optical filter is manufactured using a Bragg grating. In the case of thin film coating etalons, the discrete reflectivity values of the arrangement of FIG. 8 can be used to implement the optical filter. It is noted however that in the case of the design of a Bragg grating according to this same arrangement, the z-transform model for discrete mirrors is only used to calculate an initial target reflection spectral response having a parabolic group delay response and which is then used to design a Bragg grating that will provide the target spectral response. The target reflection spectral response is to be used to provide a unitary reference which is compatible with Bragg grating technology. The initial target modeled with the z-transform is used to ensure that the inverse scattering target is physically achievable.

### Bragg Grating Design

One possible method for designing a Bragg grating showing a negative curvature of its group delay response would be to use the calculated response of a predetermined arrangement of reflective elements as an input of an inverse scattering algorithm. For example, the arrangement of FIG. 8 could be used. As will be detailed hereinafter, the target reflection and group delay spectra are made by replicating in wavelength the unitary spectrum (calculated over one bandwidth corresponding to the FSR). The resultant target spectrum is used as an input to the inverse scattering algorithm which determines the Bragg grating profile required to produce the target spectrum. A Bragg grating having the determined profile can then be manufactured using any method known in the art, for example using ultra-violet exposure of an optical fiber using a complex phase mask (see for example U.S. Pat. No. 7,068,884 to Rothenberg). As will be detailed herein below, a group delay slope may be added to the target spectrum in order to obtain a distributed grating profile, i.e. a chirped Bragg grating.

In order to perform this design method, an arrangement of reflective elements providing the required spectral response should first be determined. For a given application, optimized values of reflectivity of each reflective element of an arrangement may be determined using an optimization algorithm, such as a genetic algorithm or a stimulated annealing method.

It is noted, however, that such an optimization algorithm may be quite complex when the number of reflective elements considered is large. The following examples illustrate an alternative method wherein the inverse scattering algorithm is performed over a target spectrum which corresponds to the wavelength replica of the unitary spectrum of a Gires-Tournois etalon (i.e. the highly reflective element is at the end).

### Example 1

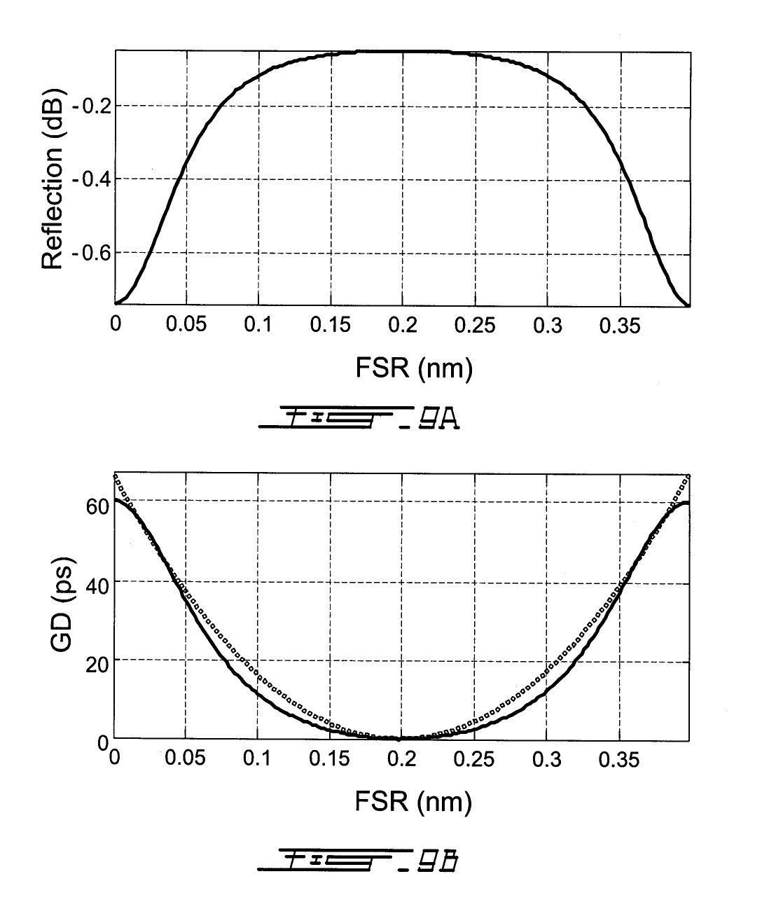

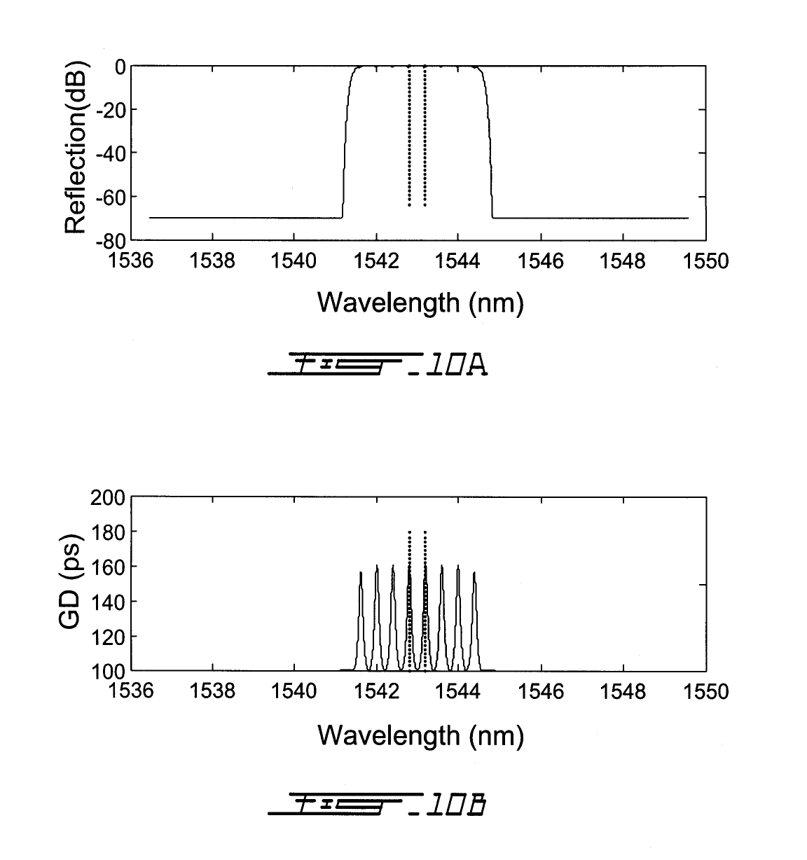

FIG. 9 shows an example of unitary spectrum which is used as an initial start point in the design of a Bragg grating optical filter. It corresponds to the unitary spectral response of the Gires-Tournois etalon of FIG. 4, i.e. R₂=1.599%, R₁=38.34%, R₀=94.988%; φ₂=0, φ₁=0. As illustrated in FIG. 10, a target spectrum is made by replicating this unitary spectrum in wavelength (seven times in this case) in order to obtain a target spectrum which is compatible with Bragg grating technology.

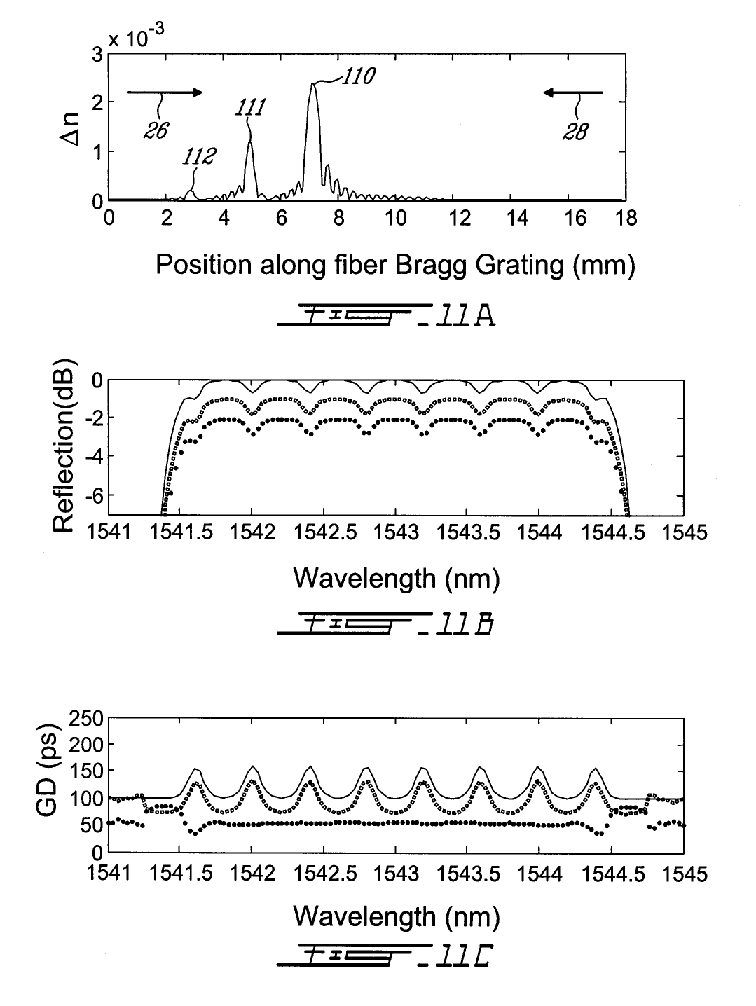

This target spectrum is then used as input to an inverse scattering algorithm (see Rosenthal A. et Horowitz M., “Inverse Scattering Algorithm for Reconstruction Strongly Reflecting Fiber Bragg Grating”, Journal of Quantum Electronics, vol. 39, no. 8, p. 1018-1026, (2003)) which calculates the Bragg grating multi-cavity profile—i.e. modulation index (Δn) and period profiles-required to obtain the target reflection and group delay response. The calculated Bragg grating design is illustrated in FIG. 11. FIG. 11A shows the Bragg grating modulation index profile. The theoretical reflection and group delay responses of the calculated Bragg grating profile for both directions of light injection are numerically calculated using the coupled mode theory (see Yamada M. et Sakuda K., “Analysis of almost-periodic distributed feedback slad waveguides via a fundamental matrix approach”, Applied Optics, vol. 26, no. 16, p. 3474-3478, (1987)). FIG. 11B shows the reflection response of the calculated Bragg grating design, wherein the solid line shows the target reflectivity spectrum, the white dots line shows the reflectivity response of the calculated Bragg grating in direct direction 26 of light injection (minus 1 dB for better visualization), and the black dots line shows the reflectivity response of the calculated Bragg grating in inverse direction 28 of light injection (minus 2 dB). FIG. 11C shows the group delay response of the calculated Bragg grating design, wherein the solid line shows the target group delay spectrum, the white dots line shows the group delay response of the calculated Bragg grating in direct direction 26 of light injection (minus 25 ps for better visualization), and the black dots line shows the group delay response of the calculated Bragg grating in inverse direction 28 of light injection (minus 50 ps).

In this case, the maximum reflectivity of the target spectrum is 0 dB. It can be seen on FIG. 11A that the Bragg grating structure obtained corresponds to the Gires-Tournois etalon arrangement used to determine the target spectrum. FIGS. 11B and 11C also show that the reflectivity and group delay response of the calculated Bragg grating profile matches the initial z-transform model. The calculated Bragg grating profile reveals a modulation index profile consisting of three distinguishable gratings (grating 110, grating 111 and grating 112), corresponding to the three reflective elements of the Gires-Tournois etalon arrangement used as a target. Grating 110 corresponds to the highly reflective element R₀ with a reflectivity of 95% and gratings 111 and 112 respectively correspond to elements R₁ and R₂ having a reflectivity of 38.4% and 1.6%. As can be seen in FIG. 11C and as can be expected for a Gires-Tournois etalon, inverse light injection does not result in an inversion of the group delay response. This filter does not correspond to the structure described in reference to FIG. 1 and to FIG. 8.

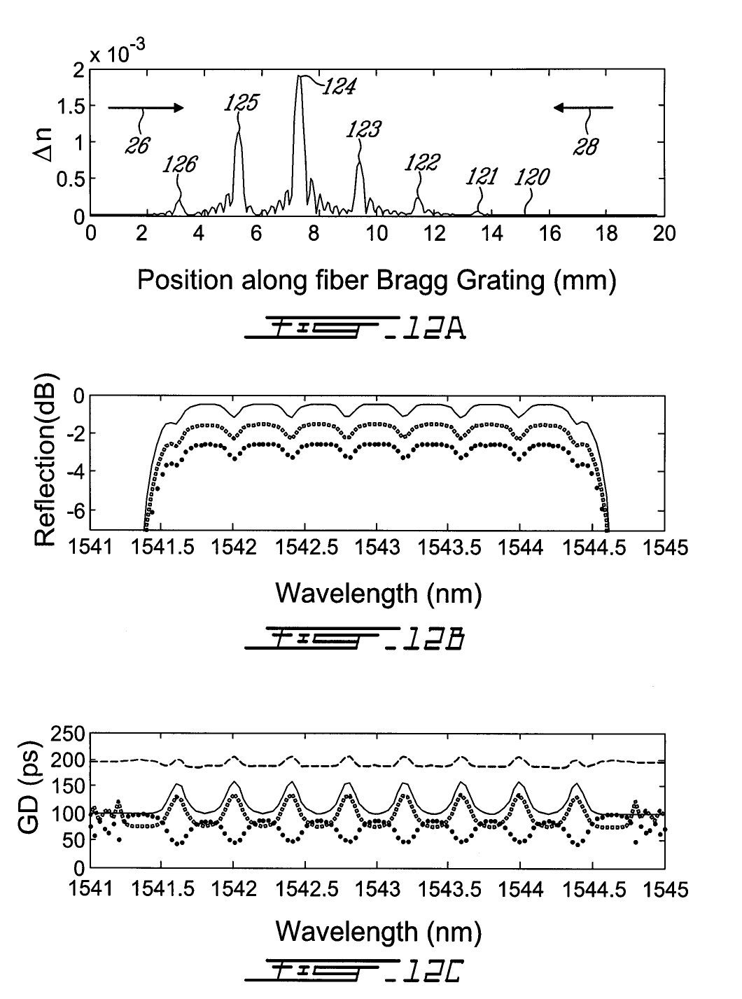

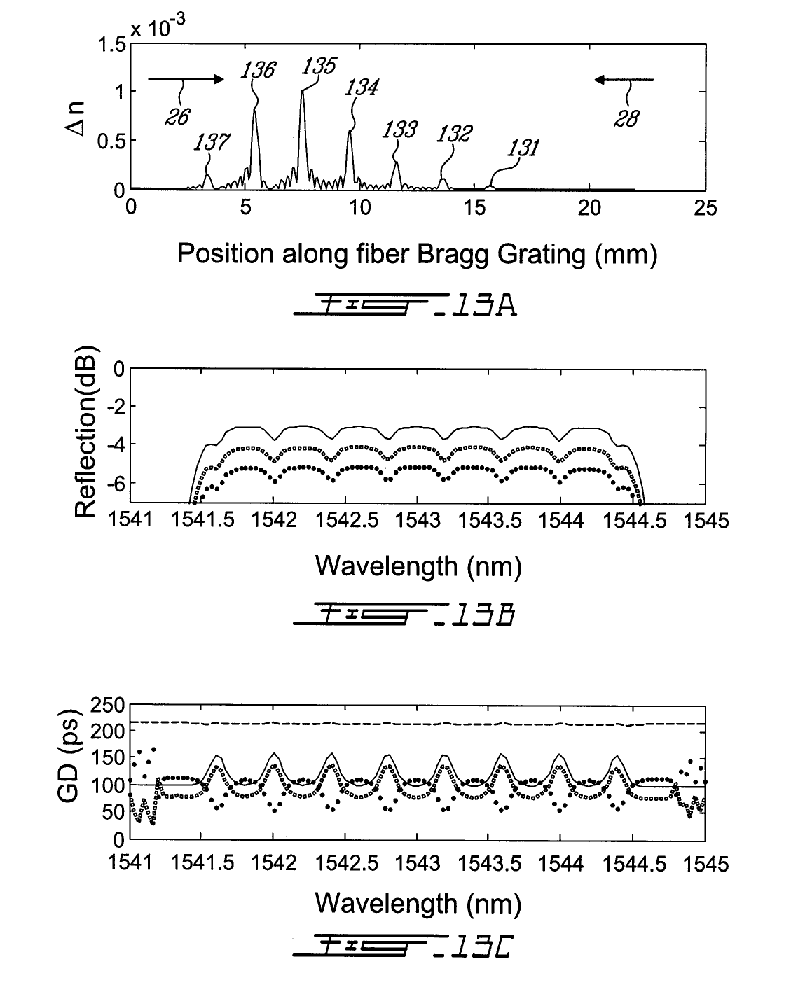

Now referring to FIGS. 12 and 13, it will be shown that a non-Gires-Tournois arrangement can be obtained by reducing the maximum reflectivity of the target spectrum before using the inverse scattering algorithm to calculate the Bragg grating profile. It is noted that FIGS. 12 and 13 depict curves equivalent to that of FIG. 11, except for an additional dashed line curve showing the summation of the direct and inverse group delay responses. The Bragg grating profiles of FIGS. 12 and 13 are obtained using the same method as the profile of FIG. 11, except that the maximum reflectivity of the target spectrum is reduced by −0.5 dB in the case of FIG. 12 and by −3 dB in the case of FIG. 13.

FIG. 12A shows that the resulting Bragg grating profile consists of seven distinguishable reflective elements (gratings 120 to 126), some of them being located after the highly reflective element (grating 124). In the case of FIG. 13A, the resulting Bragg grating profile consists of eight distinguishable reflective elements (gratings 130 to 137), some of them being located after the highly reflective element (grating 135). Accordingly, in both cases, the Bragg grating profile obtained by inverse scattering does not correspond to a Gires-Tournois structure. As shown in FIGS. 12C and 13C, the group delay response of the designed Bragg grating profile does correspond to the target spectrum in direct light injection 26 but, furthermore, the inverse light injection shows a parabolic group delay response with a negative second derivative.

In addition to the curves depicted in FIG. 11C, a new curve (dashed line) is provided in FIGS. 12C and 13C, showing the summation of the direct and inverse group delay responses of the designed Bragg grating profile. In the case of FIG. 12C, it can be seen that the summation results in a uniform group delay over more than half the FSR. This shows that the inverse group delay response is similar but inverted compared to the direct group delay response, over a bandwidth which is wider than half the FSR. FIG. 13A shows that the Bragg grating arrangement shows one more reflective element added at the end of the structure compared to FIG. 12A. It can be seen that this additional element results in direct and inverse group delay responses which are complementary, i.e. the sum of both equals zero, over a wider range when compared to FIG. 12C. These examples illustrate the ability of this method to design Bragg grating filters showing a parabolic group delay response with a negative second derivative over a given bandwidth. It further shows that this method can be used to design Bragg grating filters showing complementary curvatures of their group delay response.

### Example 2

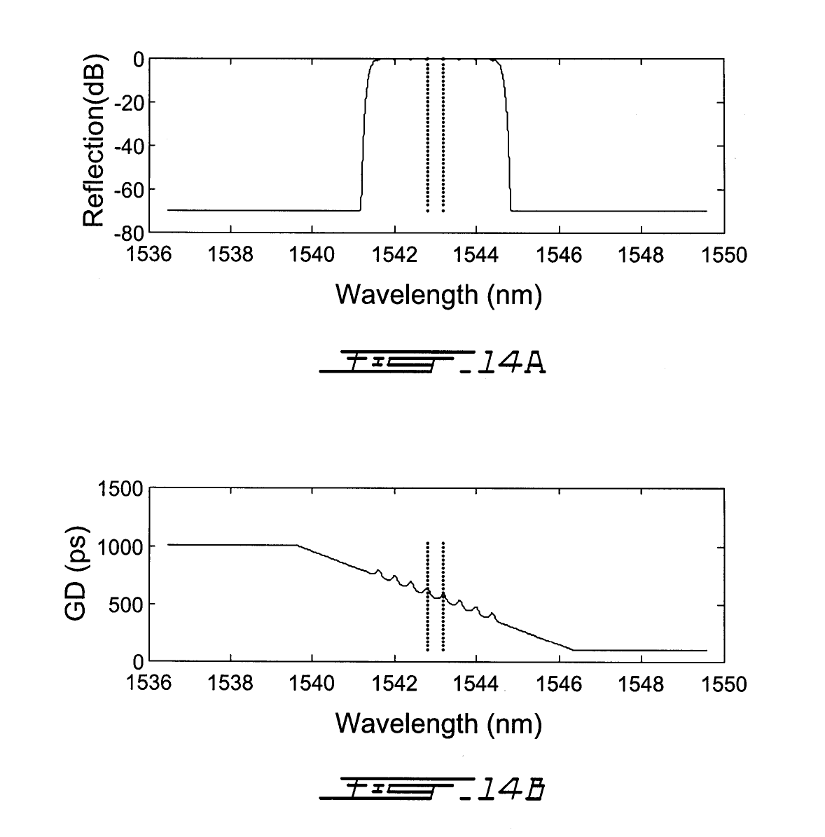

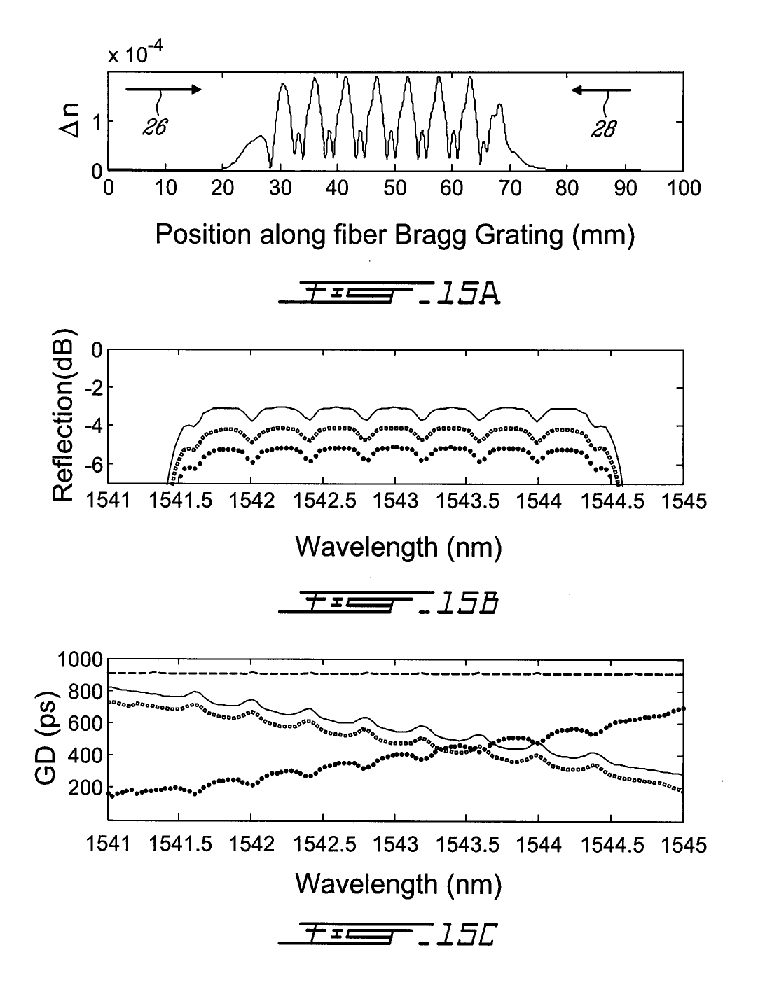

In FIGS. 12 and 13, the Bragg grating filters obtained consist of substantially separate reflective gratings spaced apart on the optical waveguide to create optical cavities. Now referring to FIG. 14, in order to obtain a chirped Bragg grating having a distributed coupled cavity structure, a monotonic group delay slope is added to the target group delay spectrum of FIG. 10. The Bragg grating compatible target spectrum of FIG. 14 is used as an input to the inverse scattering algorithm, with a maximum reflectivity of −3 dB. FIG. 15 shows the distributed coupled cavity Bragg grating structure obtained using an inverse scattering algorithm applied on the target spectrum of FIG. 14. FIG. 15 depicts curves equivalent to that of FIGS. 12 and 13. Similarly to the design of FIG. 13 and as can be seen in FIG. 15C, the distributed coupled cavity Bragg grating shows direct and inverse group delay responses that are similar but inverted. The summation of the direct and inverse group delay responses shows that they are complementary over a wide range.

It is noted that, in fact, the Bragg grating profile obtained by inverse scattering corresponds to an arrangement of spatially distributed reflective elements. The reflective elements consist of a plurality of chirped Bragg gratings and which are positioned along the optical waveguide to provide the multi-cavity structure. The length of each chirped grating being longer than the length of each cavity, the provided chirped gratings physically overlaps along the optical waveguide and this explains why they are not distinguishable in the profile shown in FIG. 15A.

### Example 3

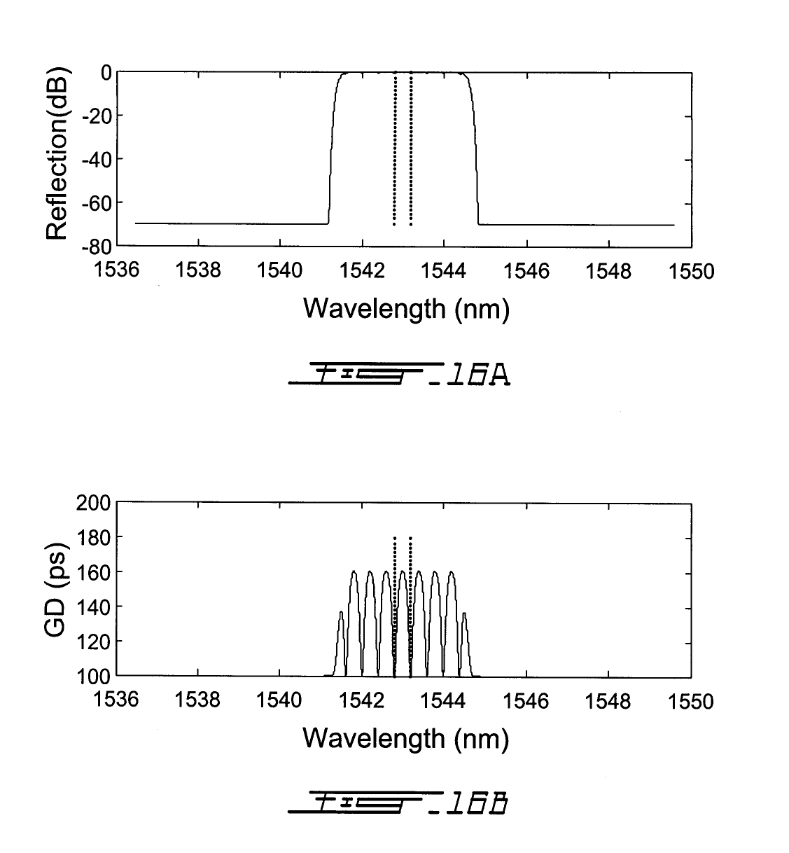

In another example of a Bragg grating design method, a negative second derivative parabolic group delay spectrum is used as the target spectrum for the inverse scattering algorithm. The target group delay spectrum is obtained by inverting the group delay response of the unitary spectrum of FIG. 9 and replicating it in wavelength. The obtained Bragg grating compatible target spectrum is illustrated in FIG. 16.

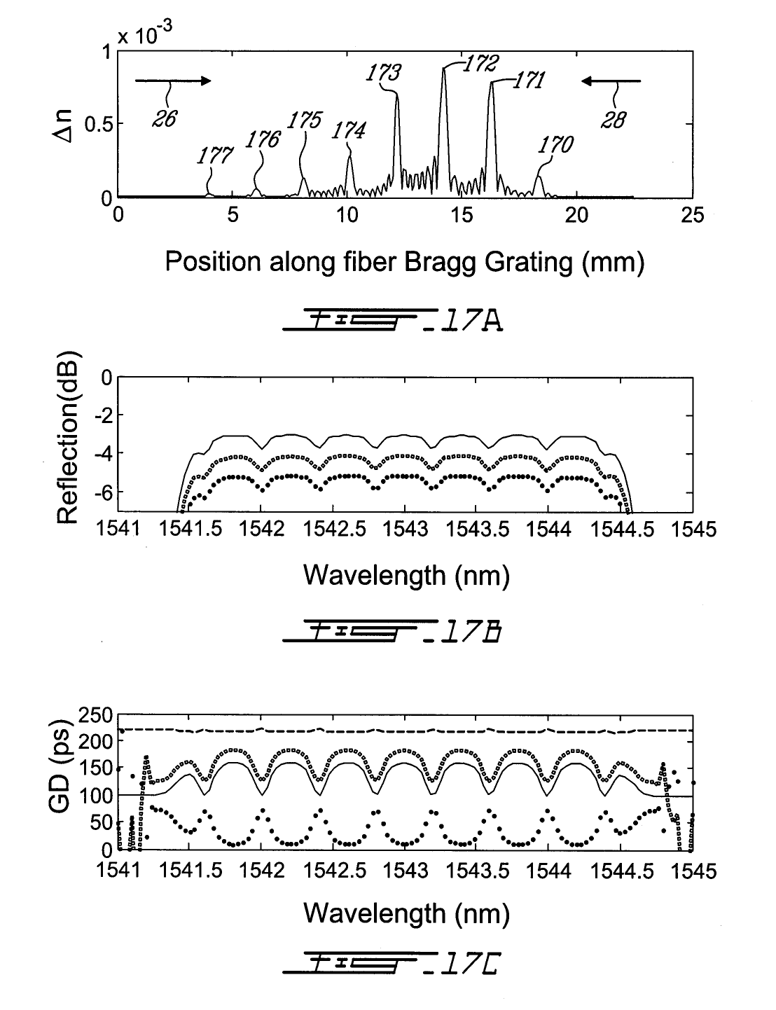

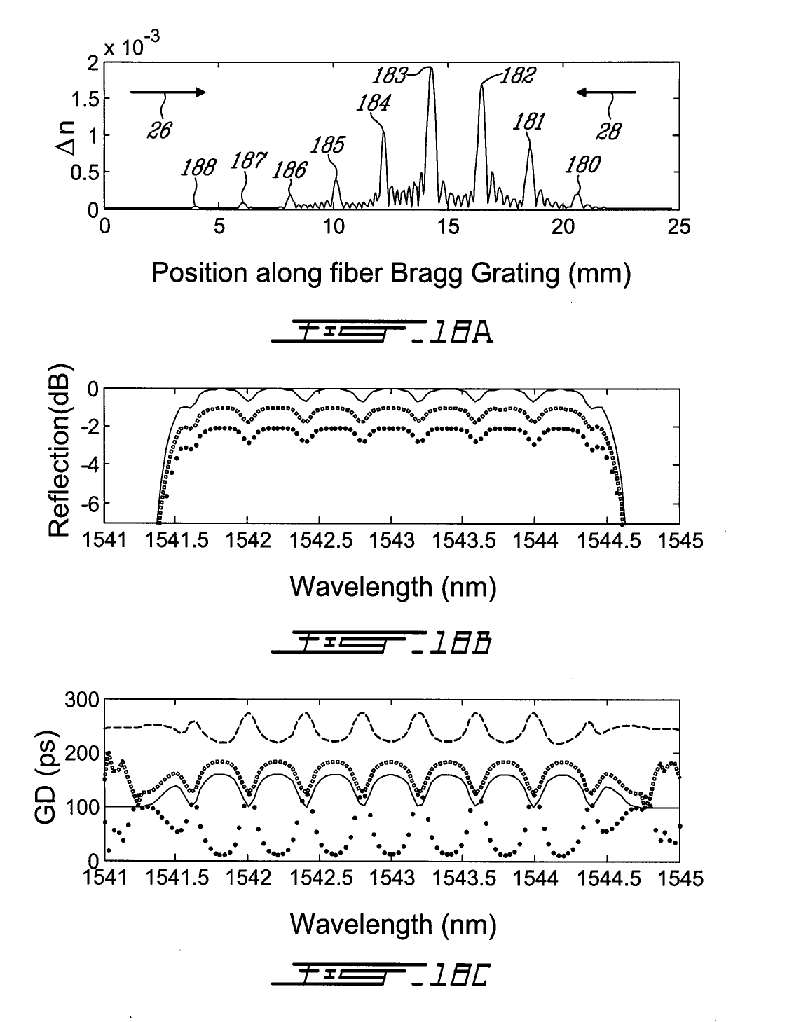

FIGS. 17 and 18 show the Bragg grating profile obtained using the target spectrum of FIG. 16 and the method described in Example 1, respectively with a maximum reflectivity of −3 dB and of −0.5 dB. Again, FIGS. 17 and 18 depict curves equivalent to that of FIGS. 12, 13 and 15. By comparing FIGS. 17A and 13a, it can be seen that the resultant Bragg grating profiles are equivalent, but inverted, i.e. grating 170 in FIG. 17A corresponds to grating 137 in FIG. 13A and grating 177 in FIG. 17A corresponds to grating 130 in FIG. 13A. A negative second derivative parabolic group delay response is observed when light is injected from one side of the Bragg grating filter, and a similar but inverted group delay response is observed when light is injected from the opposite side.

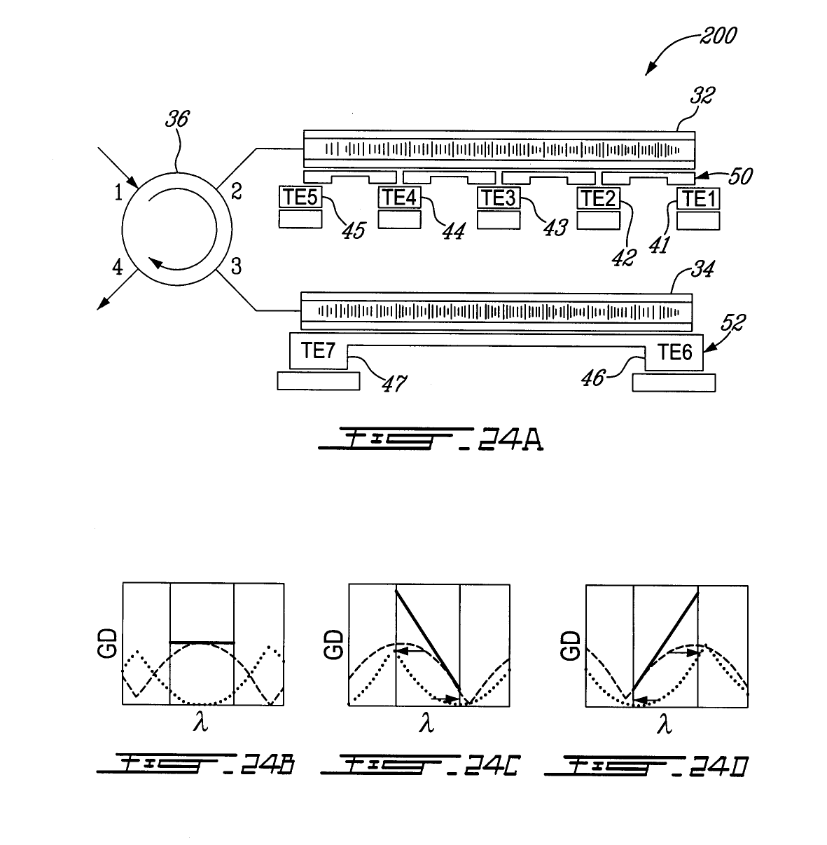

In the case of the design of FIG. 18, the positive second derivative group delay response shows a higher curvature than the negative second derivative group delay response. Consequently, the summation of the two shows a parabolic shape with a positive second derivative. As will be better understood in reference to section “TUNABLE CHROMATIC DISPERSION COMPENSATOR” below, this behavior may be used, for example, into the tunable dispersion compensation device of FIG. 24 in order to provide a tunable first order chromatic dispersion compensator in which the second order of the chromatic dispersion is not equal to zero.

The above described methods can be used to design different versions of Bragg grating filters with negative group delay curvatures with different target values and over varied bandwidths.

The above numerical methods for determining a Bragg grating profile are typically performed by a computer program or software. The software typically outputs the determined profile by saving in a file the data corresponding to the profile and calculated by the software. For example, the profile can also be transmitted to a manufacturing platform for writing a Bragg grating based on the determined profile, or to a system for manufacturing a complex phase mask embedding the determined profile.

As described hereinabove, the method for determining a Bragg grating profile is as follows: An arrangement of a plurality of cascaded reflective elements is first provided. As in Example 1, the arrangement may be a Gires-Tournois arrangement. The number of reflective elements of the arrangement and their reflectivity values, phases and distances therebetween are chosen as a function of the optical response to be filter to be designed. For example, the arrangement of reflective elements may be inputted to the computer program performing the method. The computer program may also calculate a suitable configuration considering specific optical spectrum characteristics to be obtained. The spectral response of the arrangement is then calculated over an optical bandwidth corresponding to the FSR of the arrangement to define a unitary target response. As exemplified hereinabove, a multi-channel target response is then provided by replicating the unitary target response in wavelength. As explained above, the multi-channel target response should have a maximum reflectivity lower than zero decibel. A Bragg grating profile based on the target optical response can then be computed using an inverse scattering algorithm. The resultant Bragg grating profile shows a parabolic group delay response with a negative second derivative over the optical bandwidth corresponding to the FSR when light is injected in one direction.

### Structure Analysis of the Bragg Grating of Example 1

The design method described herein above in Example 1 results in a Bragg grating profile consisting of a cascade of a plurality of substantially separate reflective elements (gratings 130 to 137 in the case of FIG. 13). This design method is particularly adapted to the manufacturing of optical filters using Bragg grating technology. The Bragg grating profile obtained can then be directly transferred to an optical waveguide using manufacturing methods known in the art (using complex phase mask exposure for example). The arrangement of reflective elements corresponding to the Bragg grating design of FIG. 13 is now analyzed. The analysis shows that the structures of the Bragg grating designs obtained herein above do correspond to the optical filter arrangement described in reference to FIG. 1. Accordingly, the design methods described above and using the spectral response of a Gires-Tournois etalon with reduced reflectivity as an initial start can also be used to identify a suitable arrangement of discrete reflective elements resulting in an optical filter showing a negative second derivative of its parabolic group delay response. The arrangement identified can then be used to manufacture an optical filter using any other optical technologies, such as thin films or integrated microring resonators for example.

In order to identify an arrangement of reflective elements resulting in the required spectral response, a Bragg grating profile is designed using one of the methods described above in Example 1 and Example 3. As opposed to the method of Example 2, a group delay slope is not added in this case to the replicated unitary group delay response, in order for the different reflective elements (gratings 130 to 137 in the case of FIG. 13) to be easily isolated. Each separate reflective element is then simulated alone to analyze its reflectivity value.

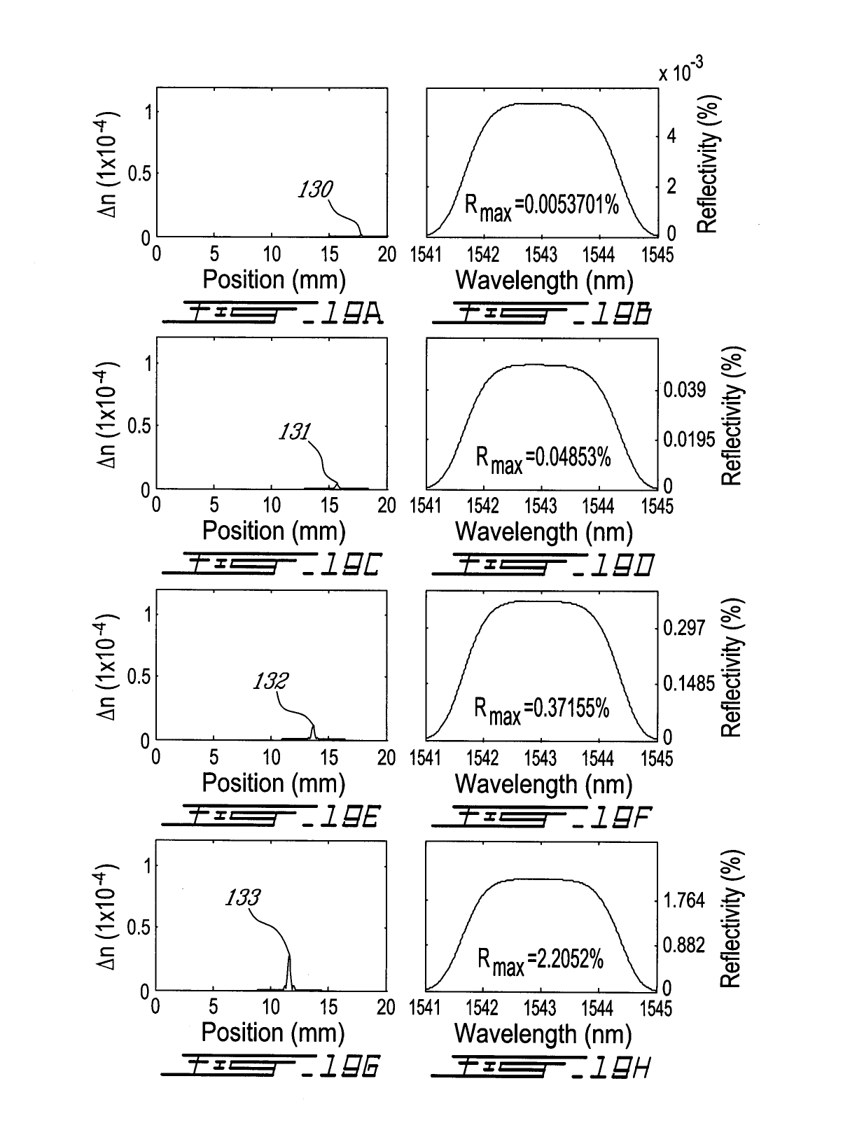

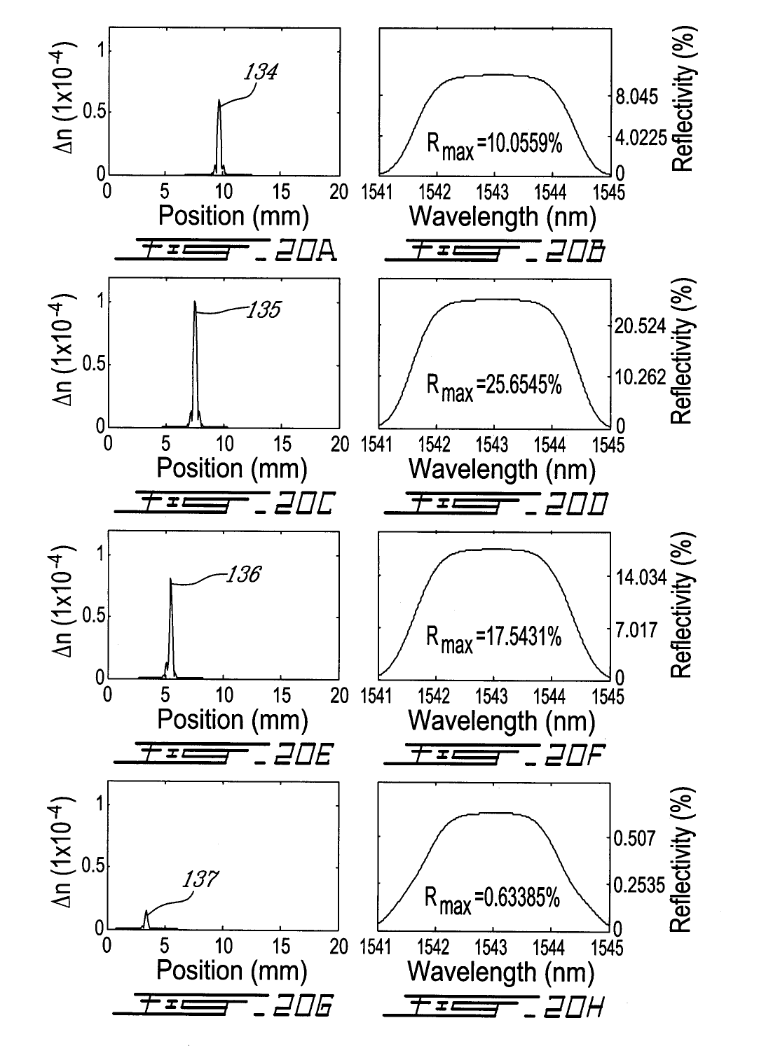

The design of FIG. 13 is analyzed now in reference to FIGS. 19, 20 and 21. FIGS. 19A, 19C, 19E and 19G respectively show the separate Bragg grating modulation index profiles of grating 130, grating 131, grating 132 and grating 133, and FIGS. 20A, 20C, 20E and 20G respectively show the separate Bragg grating modulation index profiles of grating 134, grating 135, grating 136 and grating 137 of the design of Example 1, FIG. 13. The Bragg grating profile corresponding to each separate grating is isolated from the others by applying an amplitude window on the Bragg grating profile of FIG. 13. This amplitude windowing is a Gaussian profile which is centered on the position of the maximum point of the index modulation profile corresponding to the grating to be isolated. For each separate grating, the reflection spectrum is numerically calculated using the coupled mode theory. FIGS. 19B, 19D, 19F and 19H show the numerically calculated reflection spectra respectively corresponding to grating 130, grating 131, grating 132 and grating 133, and FIGS. 20B, 20D, 20F and 20H show the numerically calculated reflection spectra respectively corresponding to grating 134, grating 135, grating 136 and grating 137. The reflectivity of each reflective element is determined using the maximum reflectivity Rₘₐₓ of each grating reflection spectrum. Accordingly, it can be shown that this particular optical filter design thus corresponds to R₀=0.0053%, R₁=0.048%, R₂=0.372%, R₃=2.205%, R₄=10.056%, R₅=25.655%, R₆=17.543% and R₇=0.634%.

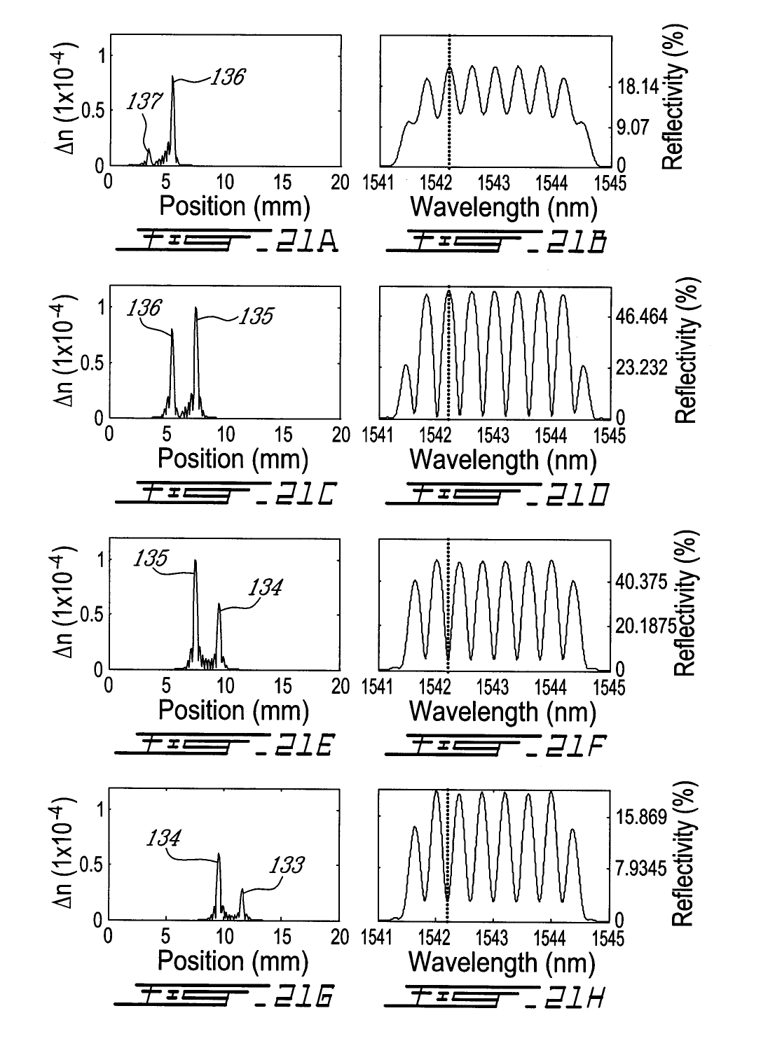

The phase difference of the cavities should also be determined. To see which cavities have phase difference of 0 and which have a phase difference of π, each pair of adjacent gratings is simulated. Each pair is thus isolated from the other gratings using a super Gaussian amplitude windowing for example. FIGS. 21A, 21C, 21E and 21G show the separate modulation index profiles of the cavities formed respectively by gratings 137 and 136, gratings 136 and 135, gratings 135 and 134, and gratings 134 and 133. FIGS. 21B, 21D, 21F and 21H show the numerically calculated reflectivity spectra respectively corresponding to the profiles of FIGS. 21A, 21C, 21E and 21G. By comparing FIG. 21B, FIG. 21D, FIG. 21F and FIG. 21H, it can be seen that the reflection spectra of the cavity formed by gratings 137 and 136 and of the cavity formed by gratings 136 and 135 show reflectivity peaks that are aligned in wavelength, while reflectivity peaks of the cavity formed by gratings 135 and 134 and by gratings 134 and 133 are spectrally shifted by one half of the FSR compared to cavity 137-136. The phase difference of each cavity is determined using this method. This particular optical filter design thus corresponds to φ₆=0, φ₅=0, φ₄=π, φ₃=π, φ₂=π, φ₁=π.

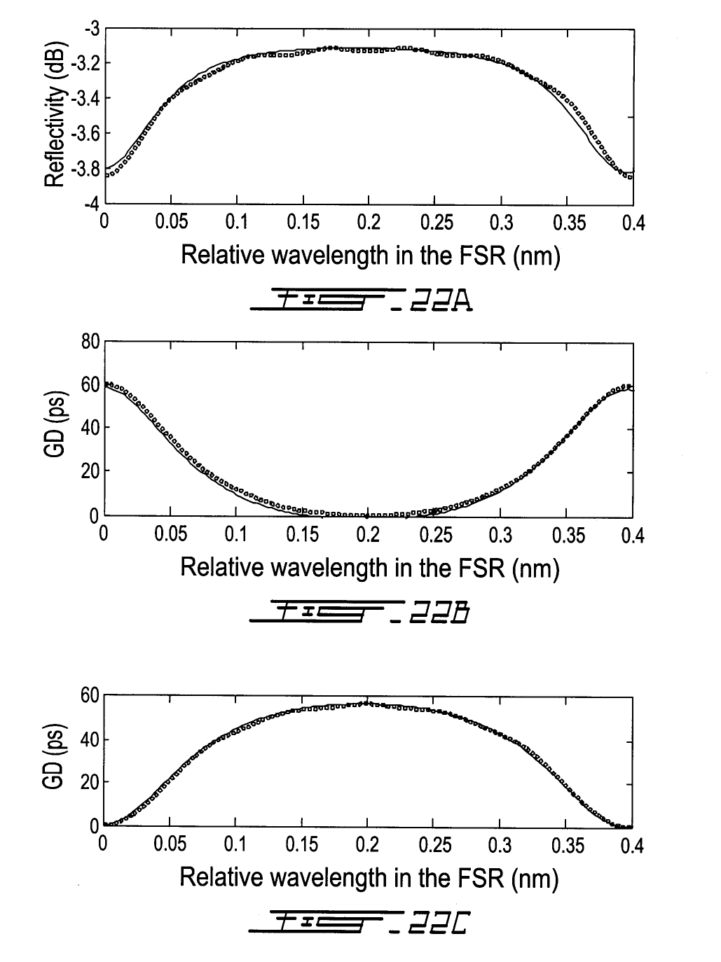

FIG. 22 compares the spectral response of the arrangement of discrete reflective elements identified using FIGS. 20 and 21 and calculated using the z-transform model, to the numerically calculated spectral response of the Bragg grating profile of FIG. 13. FIG. 22A shows the reflectivity spectrum, FIG. 22B shows the group delay spectrum in direct light injection and FIG. 22C shows the group delay spectrum in inverse light injection. It can be seen that the spectra obtained with the z-transform discrete elements and with the Bragg grating profile are quasi identical. The small difference between both arises most probably from an inaccuracy in the determination of the reflectivity values of gratings 130 to 137. This confirms that the output of the design method used in Example 1 or Example 3 corresponds to an arrangement of reflective elements as described in reference to FIG. 1. This also shows that the identified structure can also be implemented using other optical technologies, such as thin films for example.

### Example 4

Another approach for designing a Bragg grating profile that results in the required unitary spectral response (over a bandwidth corresponding to one FSR) is to first identify the z-transform polynomial which corresponds to the unitary reflection spectrum to be met. Equation (7) can be rewritten as follows:

$$R ( z ) = \frac{{\sum }_{i = 0}^{N} {b}_{i} {z}^{- i}}{{\sum }_{i = 0}^{N} {a}_{i} {z}^{- i}} , \qquad ( 13 )$$

where aᵢ and bᵢ are respectively the coefficients of the z-polynomials A(z) and B(z). Accordingly, the coefficients aᵢ and bᵢ of the A(z) and B(z) polynomials of equation (7) are directly determined using an optimization regression algorithm.

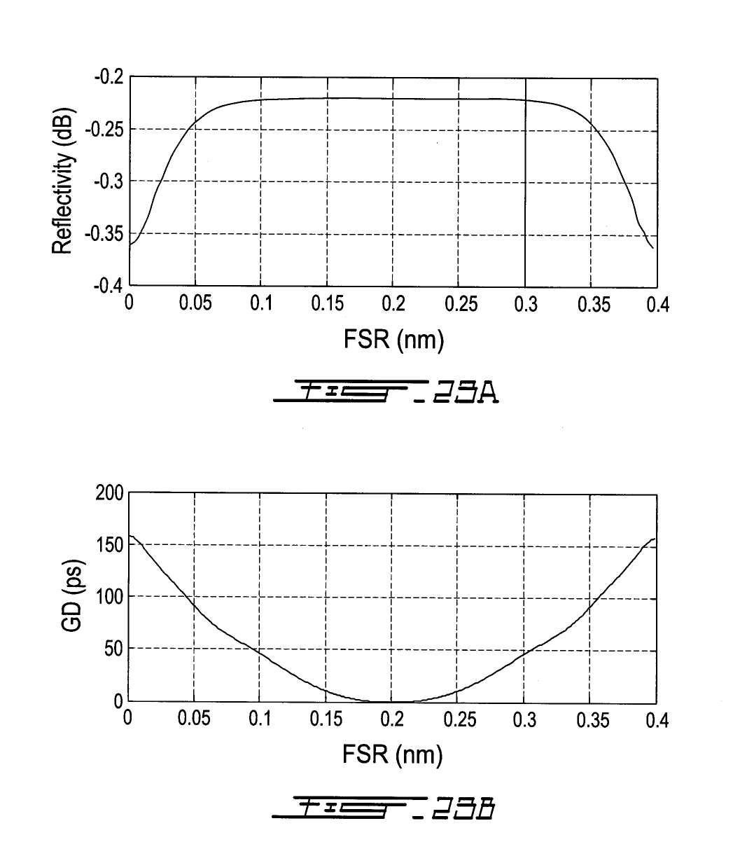

FIG. 23 shows an example unitary spectral response which corresponds to the polynomial coefficients of Table 1 which were obtained using such an optimization algorithm.

TABLE 1
Polynomial coefficients corresponding to unitary spectrum of FIG. 23.

| i | aᵢ | bᵢ |
|---|---|---|
| 0 | 1 | 0.031798 |
| 1 | −0.070692 | −0.119285 |
| 2 | −0.047227 | 0.318430 |
| 3 | −0.027616 | −0.544697 |
| 4 | −0.014772 | 0.323436 |
| 5 | −0.008110 | 0.387400 |
| 6 | −0.005166 | −0.096350 |
| 7 | −0.005004 | −0.345703 |
| 8 | −0.003902 | −0.312054 |
| 9 | −0.000799 | −0.203658 |
| 10 | 0.001607 | −0.117094 |
| 11 | −0.002783 | −0.061735 |
| 12 | 0.000658 | −0.028883 |
| 13 | −0.000428 | −0.013477 |

FIGS. 23A and 23B respectively show the unitary reflectivity response and the unitary group delay response in direct light injection. As described above, a target spectrum for the Bragg grating design is made by replicating this unitary direct or inverse spectrum in wavelength. A monotonic group delay slope is then typically added to the replicated unitary group delay spectrum in order to obtain a Bragg grating profile having a distributed coupled cavity structure, i.e. the structure has an underling chirp. A Bragg grating design is then calculated by inverse scattering.

### Tunable Chromatic Dispersion Compensator

One particular application of the optical filters is for the manufacturing of tunable chromatic dispersion compensators. It is however noted that other applications are possible, such as dispersion slope compensation or chromatic dispersion encoder/decoder for example.

Now referring to FIG. 24A, in an example application, a tunable dispersion compensating device 200 is obtained by cascading two optical filters having complementary—i.e. similar but inverted—parabolic group delay responses. Both filters 32 and 34 have a substantially parabolic group delay response, one optical filter 32 having a positive second derivative of the group delay (or positive chromatic dispersion slope) and the other optical filter 34 having a negative second derivative of the group delay. The two optical filters 32 and 34 are combined using a four-port optical circulator 36 wherein the optical signal enters through port 1 of the optical circulator 36, optical filter 32 is connected to port 2, optical filter 34 is connected to port 3 and the compensated optical signal exits through port 4. FIGS. 24B, 24C and 24D show the group delay responses (over one FSR) of each optical filter 32, 34 individually and combined in device 200. The dotted lines show the response of optical filter 32, the dashed lines show the response optical filter 34 and the solid lines show the response of the device 200, which corresponds to the summation of the responses of optical filters 32 and 34. When cascading the two optical filters 32 and 34, the quadratic components of their respective group delay responses substantially cancel out and the total group delay response is substantially linear over a spectral band. As shown in FIGS. 24B, 24D and 24D, a spectral shift of the spectral responses of the optical filters 32, 34 with respect to one another results in a tuning of the chromatic dispersion of the cascade in device 200. In FIG. 24B, both optical filters 32 and 34 are spectrally aligned and the group delay resulting from the combination of the two is linear and the chromatic dispersion (group delay slope) is zero. In FIG. 24C, optical filter 32 is shifted positively in wavelength relative to optical filter 34. The resulting group delay is also linear but shows a negative chromatic dispersion (or group delay slope). In FIG. 24D, optical filter 32 is shifted negatively in wavelength relative to optical filter 34. The resulting group delay shows a positive chromatic dispersion.

In the illustrated case, the spectral shifts are provided by varying the temperature of the optical filters using thermoelectric elements 41, 42, 43, 44, 45, 46 and 47. An optical waveguide holder 50 with thermoelectric elements 41, 42, 43, 44, and 45 is used to produce a temperature profile that induces a wavelength shift in optical filter 32 while an optical waveguide holder 52 with thermoelectric elements 46 and 47 is used to induce a wavelength shift in optical filter 34. Applying a uniform thermal offset along each optical filter 32 and 34 provides a wavelength offset of its respective response.

It is noted that, when applying a uniform thermal offset to the optical filters 32, 34, the FSR are slightly altered and, as a consequence, the chromatic dispersion tuning is not uniform from channel to channel. A thermal gradient is thus added by the use of at least two thermoelectric elements per optical filter 32, 34, one at each end of the optical filter. A proper choice of thermal gradient provides uniform chromatic dispersion from channel-to-channel.

Determination of the temperature profiles required to spectrally shift the group delay response of the optical filter 32 and 34 is described in more details in U.S. Pat. No. 7,251,396 to Larochelle et al., wherein other possible temperature profiles are also described.

It is noted that the spectral shifts could be performed using other perturbation means such as mechanical strain, electric or magnetic field if the substrate of the optical filter is responsive to such a perturbation, or current injection in the case of a semiconductor filter. The optical circulator 36 could also be replaced by any other optical means allowing the optical cascade of the two optical filters 32 and 34.

One or both optical filters 32 and 34 may use an optical filter as described herein in reference to FIG. 1 or FIG. 12, 13, 15, 17 or 18. If the optical filter design of FIG. 12, 13, 15 or 17 is used, the same design can be used for both optical filters 32 and 34. The optical filter 32 then uses the design in direct light injection direction while the optical filter 34 uses the same design in inverse light injection. In this case, only one optical design may be calculated and all optical filters 32 and 34 may be manufactured according to the same design. The tunable dispersion compensating device 200 may then be made by manufacturing and assembling two samples of the same optical filter design. The optical design of FIG. 18 may also be used in both optical filters 32 and 34 if a second order of chromatic dispersion is to be compensated for.

It is noted that the optical filters 32 and 34 may also use different designs. For example, a design according to FIG. 1, FIG. 12, 13, 15, 17 or 18 may be used to provide optical filter 34 while a distributed Gires-Tournois etalon, such as the one of FIG. 11, is used to provide optical filter 32. When non-Gires-Tournois designs are used, the inverse group delay shape (negative second derivative) covers a bandwidth compared to Gires-Tournois based filters. This larger usable channel bandwidth increases the chromatic dispersion tuning range by allowing a larger spectral shift between the spectral responses of the two filters of the cascade.

It should be noted that, while the one possible implementation of the optical filters described herein uses fiber Bragg grating technology, other technologies could be used to make the arrangement of reflective elements. In the embodiments described herein, the Bragg grating filters are manufactured in optical fibers but it is noted that other suitable light-guiding structures could also be used, such as planar or channel waveguides for example. Optical fibers and other waveguides may be made of various materials including silica, chalcogenide glasses, fluoride glasses, semi-conductors, organic materials and polymers.

The optical filters described herein may also find other applications. For example, such optical filters may be used when optical devices with group delay inversion are required. The proposed arrangement of reflective elements may also be used when the reflection magnitude of each reflective element is limited due to the manufacturing technology.

Furthermore, it is noted that, while in the illustrated arrangement the cavities before and after the highly reflective mirror are out of phase with a phase difference of π, the change of phase may otherwise occur at a different position in the arrangement. Table 2 provides other various suitable designs:

TABLE 2
Various possible designs of optical filters.

| Structure | | | |
|---|---|---|---|
| parameters | Design 1 | Design 2 | Design 3 |
| R₀ | 0.12% | 0.14% | 0.2% |
| φ₁ | π | π | π |
| R₁ | 0.29% | 0.39% | 0.54% |
| φ₂ | π | π | π |
| R₂ | 0.93% | 1.2% | 1.23% |
| φ₃ | π | π | π |
| R₃ | 3.08% | 4.3% | 3.51% |
| φ₄ | π | π | π |
| R₄ | 11.11% | 14.32% | 9.46% |
| φ₅ | π | π | π |
| R₅ | 33.42% | 38.90% | 22.17% |
| φ₆ | π | π | π |
| R₆ | 58.56% | 65.04% | 39.3% |
| φ₇ | 0 | 0 | π |
| R₇ | 59% | 63.45% | 20.6% |
| φ₈ | 0 | 0 | 0 |
| R₈ | 15.42% | 19.52% | 68.75% |
| φ₉ | 0 | 0 | 0 |
| R₉ | 1.31% | 3.32% | 37.65% |
| φ₁₀ | | 0 | 0 |
| R₁₀ | | 0.04% | 10% |
| φ₁₁ | | | 0 |
| R₁₁ | | | 1.15% |
| φ₁₂ | | | 0 |
| R₁₂ | | | 0.11% |

The embodiments described above are intended to be exemplary only. The scope of the invention is therefore intended to be limited solely by the appended claims.

1. A multi-cavity optical filter having a first and a second direction of light injection comprising:
a highly reflective element; and
a front reflective element and a back reflective element, each having a reflectivity lower than that of said highly reflective element, said front reflective element being located on one side of said highly reflective element and forming a front optical cavity with said highly reflective element, said back reflective element being located on the other side of said highly reflective element and forming a back optical cavity with said highly reflective element, said first and said second cavities having a phase difference of π;
wherein said optical filter shows a first substantially parabolic group delay response with a negative second derivative when light is injected in a first direction of light injection.

2. The optical filter as claimed in claim 1, wherein said highly reflective element and said front and back reflective elements are distributed reflective elements provided as a chirped Bragg grating.

3. The optical filter as claimed in claim 2, wherein said optical filter is inscribed in an optical fiber as a chirped fiber Bragg grating.

4. The optical filter as claimed in claim 1, wherein said optical filter has a second substantially parabolic group delay response with a positive second derivative when light is injected in said second direction of light injection and wherein an absolute value of said negative second derivative is substantially equal to an absolute value of said positive second derivative.

5. A multi-cavity optical filter having a first and a second direction of light injection comprising:
a plurality of cascaded reflective elements comprising a highly reflective element having a reflectivity higher than other ones of said reflective elements, and at least one element of lower reflectivity on each side of said highly reflective element, said reflective elements providing a plurality of optical cavities; and
wherein said optical filter is characterized by a free spectral range and shows a first substantially parabolic group delay response with a negative second derivative over a spectral bandwidth corresponding to said free spectral range when light is injected in said first direction.

6. The optical filter as claimed in claim 5, wherein consecutive ones of said optical cavities are grouped into two groups of at least one cavity, cavities of a first one of said groups having a phase of π and cavities of a second one of said groups having a phase of zero.

7. The optical filter as claimed in claim 6, wherein cavities of said first one are located on one side of said highly reflective element and cavities of said second one are located on another side of said highly reflective element.

8. The optical filter as claimed in claim 5, wherein said reflective elements are distributed reflective elements provided as a chirped Bragg grating.

9. The optical filter as claimed in claim 8, wherein said optical filter is inscribed in an optical fiber as a chirped fiber Bragg grating.

10. The optical filter as claimed in claim 5, wherein said optical filter shows a second substantially parabolic group delay response with a positive second derivative over said spectral bandwidth when light is injected in said second direction and wherein an absolute value of said negative second derivative is substantially equal to an absolute value of said positive second derivative.

11. A tunable chromatic dispersion compensator comprising:
a first optical filter having a first substantially parabolic group delay response with a negative second derivative, and a second optical filter having a second substantially parabolic group delay response with a positive second derivative, said first optical filter and said second optical filter being optically cascaded to provide a total group delay response having a slope defining a chromatic dispersion; and
tuning means for shifting in wavelength said first substantially parabolic group delay response and for shifting in wavelength said second substantially parabolic group delay response, said first and said second optical filter to be shifted in opposite wavelength directions to tune said chromatic dispersion; and
wherein said first optical filter comprises an arrangement of a plurality of cascaded reflective elements comprising a highly reflective element having a reflectivity higher than other ones of said reflective elements, and at least one element of lower reflectivity on each side of said highly reflective element, said reflective elements providing a plurality of optical cavities.

12. The tunable chromatic dispersion compensator as claimed in claim 11, wherein said first and said second optical filters comprise the same arrangement of said plurality of cascaded reflective elements, said plurality of cascaded reflective elements having a first and a second direction of light injection, said first and said second optical filters being cascaded such that an optical signal is to enter said first optical filter in said first direction of light injection and to enter said second optical filter in said second direction of light injection.

13. The tunable chromatic dispersion compensator as claimed in claim 11, wherein consecutive ones of said optical cavities are grouped into two groups of at least one cavity, cavities of a first one of said groups having a phase of π and cavities of a second one of said groups having a phase of zero.

14. The tunable chromatic dispersion compensator as claimed in claim 13, wherein cavities of said first one are located on one side of said highly reflective element and cavities of said second one are located on another side of said highly reflective element.

15. The tunable chromatic dispersion compensator as claimed in claim 11, wherein said first and said second optical filters are provided as chirped Bragg gratings.

16. The tunable chromatic dispersion compensator as claimed in claim 11, wherein said tuning means comprises a first thermal element for providing a first thermal offset to said first optical filter and a second thermal element for providing a second thermal offset to said second optical filter.

17. The tunable chromatic dispersion compensator as claimed in claim 16, wherein said dispersion compensator is a multi-channel dispersion compensator, wherein said first and said second optical filters each have a free spectral range and wherein said tuning means further comprises a third thermal element for, in combination with said first thermal element, applying a thermal gradient to said first optical filter to adjust its free spectral range, and a fourth thermal element for, in combination with said second thermal element, applying a thermal gradient to said second optical filter to adjust its free spectral range.

18. A method for manufacturing a multi-channel optical filter based on a Bragg grating, said method comprising:
providing an arrangement of a plurality of cascaded reflective elements comprising a highly reflective element having a reflectivity higher than other ones of said reflective elements, and at least two elements of lower reflectivity, said reflective elements defining a plurality of optical cavities characterized by a free spectral range;
calculating said spectral response over an optical bandwidth substantially corresponding to said free spectral range to define a unitary target response, said unitary target response showing a substantially parabolic group delay response;
providing a multi-channel target response by replicating said unitary target response in wavelength, said multi-channel target response having a maximum reflectivity lower than zero decibel;
computing a Bragg grating profile based on said target optical response and using an inverse scattering algorithm, said Bragg grating profile showing a substantially parabolic group delay response with a negative second derivative over said optical bandwidth for one direction of light injection; and
writing said profile in an optical waveguide to provide said optical filter.

19. The method as claimed in claim 18, further comprising manufacturing a complex phase mask corresponding to said profile and wherein said writing comprises exposing said optical waveguide using said phase mask.

20. A method for determining a Bragg grating profile, said method comprising:
providing an arrangement of a plurality of cascaded reflective elements comprising a highly reflective element having a reflectivity higher than other ones of said reflective elements, and at least two elements of lower reflectivity, said reflective elements defining a plurality of optical cavities characterized by a free spectral range;
calculating said spectral response over an optical bandwidth substantially corresponding to said free spectral range to define a unitary target response, said unitary target response showing a substantially parabolic group delay response;
providing a multi-channel target response by replicating said unitary target response in wavelength, said multi-channel target response having a maximum reflectivity lower than zero decibel;
computing a Bragg grating profile based on said target optical response and using an inverse scattering algorithm, said Bragg grating profile showing a substantially parabolic group delay response with a negative second derivative over said optical bandwidth for one direction of light injection; and
outputting said Bragg grating profile.

21. The method as claimed in claim 18, wherein said providing a multi-channel target response comprises adding a monotonous group delay slope to the replicated unitary target response.

22. The method as claimed in claim 18, wherein said calculating is made using a z-transform calculation.

23. The method as claimed in claim 18, wherein at least one of said elements of lower reflectivity is located on each side of said highly reflective element.
